(19) United States
(12) Patent Application Publication
(10) Pub. No.: US 2013/0135364 A1
(43) Pub. Date: May 30, 2013

(54) METHODS AND APPARATUS FOR INTERPOLATING COLORS

(71) Applicant: QUALCOMM MEMS Technologies, Inc., San Diego, CA (US)

(72) Inventor: Alok Govil, Santa Clara, CA (US)

(73) Assignee: QUALCOMM MEMS Technologies, Inc., San Diego, CA (US)

(21) Appl. No.: 13/679,912

(22) Filed: Nov. 16, 2012

Related U.S. Application Data
(60) Provisional application No. 61/565,327, filed on Nov. 30, 2011.

(51) Int. Cl. G09G 5/02

(52) U.S. Cl. CPC G09G 5/02; G09G 2320/0666
USPC 345/690

(57) ABSTRACT

This disclosure provides methods, apparatus, and computer programs encoded on computer storage media for converting drive instructions for a plurality of display devices to drive instructions for a first display device. In one aspect, a method includes processing the drive instructions for the plurality of display devices to produce a first color in a set of potential colors for the plurality of display devices, selecting a color for the first display device that approximates the produced first color, displaying the selected color with the first display device, determining an error between the selected color and the produced first color, and diffusing the error by displaying at least another color on at least a portion of the plurality of display devices.

### CROSS-REFERENCE TO RELATED APPLICATIONS

This application claim priority under 35 U.S.C. Section 119(e) to U.S. Provisional Application 61/565,327, filed Nov. 30, 2011, entitled “Methods and Apparatus for Interpolating Colors with an Analog IMOD” which is hereby incorporated by reference in its entirety.

This application is also related to U.S. patent application Ser. No. ______ (Attorney Docket No. QC0.409A/092821U1), filed ______, entitled “COLOR INTERPOLATION ALGORITHMS FOR ANALOG IMOD and to U.S. patent application Ser. No. ______ (Attorney Docket No. QC0.409A2/092821U2), filed ______, entitled “COLOR INTERPOLATION ALGORITHMS FOR ANALOG IMOD,” both of which are assigned to the assignee of the present invention.

### TECHNICAL FIELD

This disclosure relates to color interpolation methods and apparatus for electromechanical systems, and in particular, to analog interferometric modulators.

### DESCRIPTION OF THE RELATED TECHNOLOGY

Electromechanical systems (EMS) include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method for converting drive instructions for a plurality of display devices to drive instructions for a first display device. The method includes processing the drive instructions for the plurality of display devices to produce a first color in a set of potential colors for the plurality of display devices. The method includes selecting a color for the first display device that approximates the produced first color, displaying the selected color with the first display device, determining an error between the selected color and the produced first color, and diffusing the error by displaying at least another color on at least a portion of the plurality of display devices. In some implementations the plurality of display devices include bistable IMODs, and wherein the first display device includes an analog IMOD. In some implementations, there are three bistable IMODs, and the set of potential colors corresponds to eight display states or voltage level combinations for the three bistable IMODs. In some implementations, the error is temporally diffused to a subsequent display period. In some implementations, the error is diffused to one or more adjacent display devices. In some implementations, each of the colors in the set of potential colors corresponds to a predetermined closest color of the first display device.

Another aspect disclosed is an apparatus for converting drive instructions for a plurality of display devices to drive instructions for a first display device. The apparatus includes an electronic display including a plurality of display devices, an electronic processor configured to communicate with the display, the processor being configured to process image data; and configured to process the drive instructions for the plurality of display devices to produce a first color in a set of potential colors for the plurality of display devices, select a color for the first display device that approximates the produced first color, display the selected color with the first display device, determine an error between the selected color and the produced first color, and diffuse the error by displaying at least another color on at least a portion of the plurality of display devices.

Some implementations of the apparatus include a memory device that is configured to communicate with the processor. Some of these implementations also include a driver circuit configured to send at least one signal to the display. Some implementations include a controller configured to send at least a portion of the image data to the driver circuit. Some implementations include an image source module configured to send the image data to the processor. In some implementations, the image source module includes at least one of a receiver, transceiver, and transmitter. In some implementations, an input device is configured to receive input data and to communicate the input data to the processor. In some implementations, the electronic display comprises analog IMODs. Some implementations of the apparatus also include a wireless telephone handset.

Another aspect discloses is an apparatus. The apparatus includes means for processing the drive instructions for a plurality of display devices to produce a first color in a set of potential colors for the plurality of display devices, means for selecting a color for a first display device that approximates the produced first color, means for displaying the selected color with the first display device, means for determining an error between the selected color and the produced first color, and means for diffusing the error by displaying at least another color on at least a portion of the plurality of display devices.

Another aspect discloses is a non-transitory, computer readable storage medium having instructions stored thereon that cause a processing circuit to perform a method. The method includes processing the drive instructions for a plurality of display devices to produce a first color in a set of potential colors for the plurality of display devices, selecting a color for a first display device that approximates the produced first color, displaying the selected color with the first display device, determining an error between the selected color and the produced first color, and diffusing the error by displaying at least another color on at least a portion of the plurality of display devices.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 shows an example of a schematic partial cross-section illustrating one implementation of the structure of the driving circuit and the associated display element of FIG. 2.

FIG. 4 shows an example of a schematic exploded partial perspective view of an optical MEMS display device having an interferometric modulator array and a backplate with embedded circuitry.

FIG. 5 shows a cross-section of an interferometric modulator having two fixed layers and a movable third layer.

FIG. 6 shows an example of a schematic circuit diagram illustrating a driving circuit array for an optical EMS display device having the structure of FIG. 5.

FIGS. 7A-7C show cross-sections of the two fixed layers and the movable layer of the interferometric modulator of FIG. 5 illustrating stacks of materials.

FIG. 8 shows a schematic representation of the interferometric modulator and voltage sources illustrated in FIG. 5.

FIG. 9A shows an example of a cross-section of an analog IMOD (AIMOD).

FIG. 9B shows an example of a cross-section of an analog IMOD (AIMOD) according to another implementation.

FIG. 10 illustrates a color space with superimposed color gamuts for a RGB parallelpiped and an analog IMOD.

FIG. 11 is a flowchart illustrating one operative implementation for a method of displaying a final color on an electronic display where each display element of the display is capable of displaying a set of native colors.

FIG. 12 is a block diagram illustrating one implementation of an apparatus for displaying a final color on an electronic display capable of displaying a set of native colors.

FIG. 13 is a flowchart illustrating another implementation of a method of displaying a final color on an electronic display where each display element of the display is capable of displaying a set of native colors.

FIG. 14 illustrates how one implementation of a method of displaying a final color on an electronic display capable of displaying a set of native colors may operate.

FIGS. 15a, 15b, and 15c illustrate one example implantation of a Perl programming language simulation and output of the method described in FIG. 13 and FIG. 14.

FIG. 16 is a flowchart illustrating another implementation of a method of displaying a final color on an electronic display capable of displaying a set of native colors.

FIG. 17 is a flowchart illustrating another implementation of a method of displaying a final color on an electronic display capable of displaying a set of native colors.

FIG. 18A illustrates one implementation utilizing a plurality of IMODs configured to display different colors that are disposed adjacent to each other.

FIG. 18B is a data flow diagram of a method for driving the three IMODs.

FIG. 19A illustrates one implementation of an analog IMOD producing a continuous color gamut.

FIG. 19B is a data flow diagram for a method of driving an analog modulator, for example, the analog modulator illustrated in FIG. 19A.

FIG. 20 is a flowchart illustrating one implementation of a method for converting drive instructions for a plurality of display devices to drive instructions for a first display device.

FIG. 21 is a flowchart illustrating one implementation of an error diffusion process.

FIG. 22 is a flowchart illustrating another implementation of an error diffusion process.

FIGS. 23A and 23B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as electromechanical systems (EMS), MEMS and non-MEMS applications), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Various implementations include methods and apparatus that utilize color interpolation to produce a visually perceived color gamut larger than is capable of being displayed by the spectrum of reflected colors that is normally produced by interferometric modulator devices. These colors physically produced by interferometric modulator devices due to physical and optical properties are also known as native colors. These methods and apparatus may enable the display of photo quality images with these display devices, which are not normally producible using the native colors. Furthermore, the methods disclosed provide flexibility in display manufacturing and part selection, by enabling a larger selection of IMOD native colors to be utilized by displays while still being able to produce (display) photo-quality images.

Particular implementations of the subject matter described in this disclosure can be implemented to realize one or more of the following potential advantages. For example, particular implementations of the subject matter described herein can realize a display with a larger color gamut as perceived by the human eye when the display is using analog interferometric modulators. Other implementations may result in reduced cost, size, or weight of a display by reducing the number of display elements that are used to realize a particular color gamut when compared to traditional technologies such as the use of red, green, and blue subpixels.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

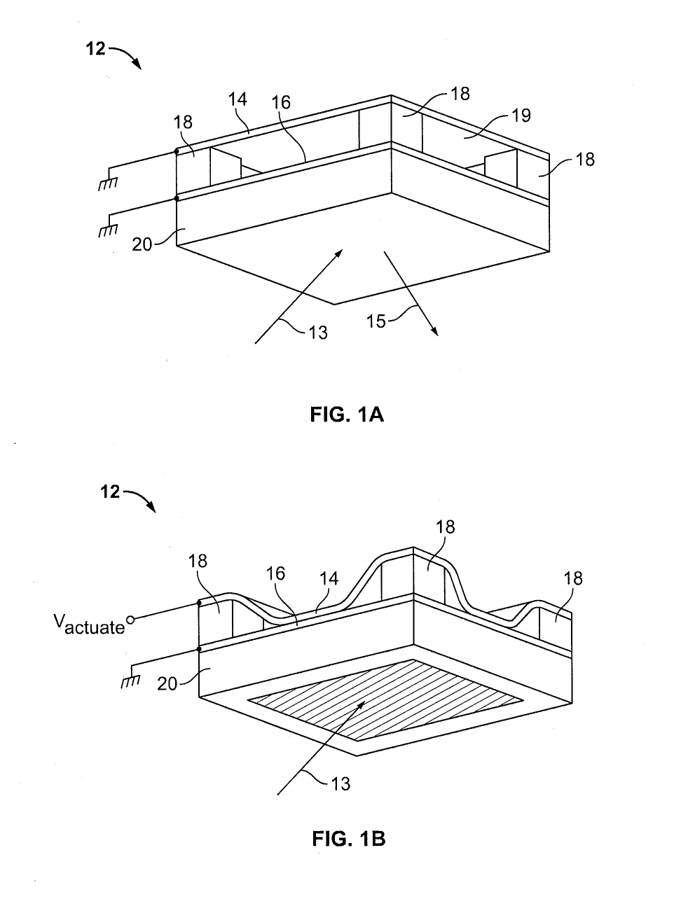

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 of FIG. 1A, a movable reflective layer 14 is illustrated in a relaxed position at a predetermined distance from an optical stack 16, which includes a partially reflective layer. Since no voltage is applied across the IMOD 12 in FIG. 1A, the movable reflective layer 14 remained in a relaxed or unactuated state. In the IMOD 12 of FIG. 1B, the movable reflective layer 14 is illustrated in an actuated position adjacent to the optical stack 16. The voltage V_{actuate} applied across the IMOD 12 in FIG. 1B is sufficient to actuate the movable reflective layer 14 to an actuated position.

In FIG. 1, the reflective properties of pixels 12 are generally illustrated with arrows 13 indicating light incident upon the pixels 12, and light 15 reflecting from the pixel 12 on the left. A person having ordinary skill in the art will readily recognize that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the lower electrode 16 is grounded at each pixel. In some implementations, this may be accomplished by depositing a continuous optical stack 16 onto the substrate and grounding the entire sheet at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, the optical stacks 16 in a series or array of IMODs can serve as a common electrode that provides a common voltage to one side of the IMODs of the display device. The movable reflective layers 14 may be formed as an array of separate plates arranged in, for example, a matrix form, as described further below. The separate plates can be supplied with voltage signals for driving the IMODs.

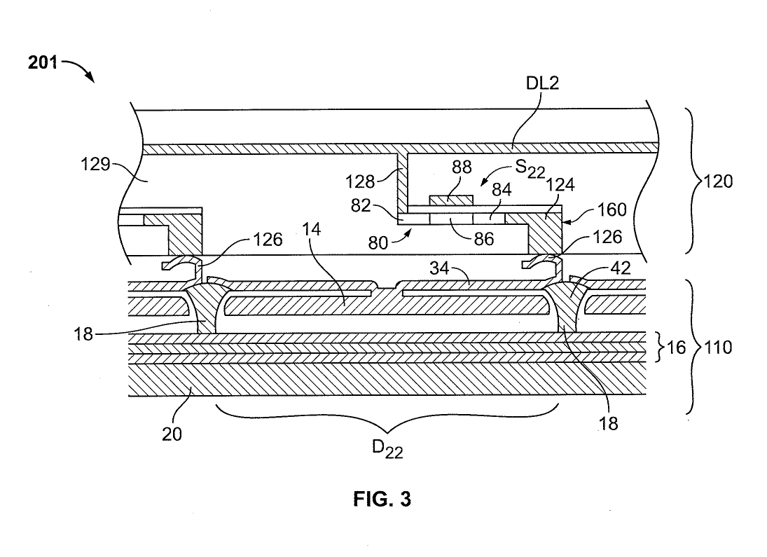

The details of the structure of interferometric modulators that operate in accordance with the principles set forth above may vary widely. For example, the movable reflective layers 14 of each IMOD may be attached to supports at the corners only, e.g., on tethers. As shown in FIG. 3, a flat, relatively rigid reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the reflective layer 14 can be optimized with respect to the optical properties, and the structural design and materials used for the deformable layer 34 can be optimized with respect to desired mechanical properties. For example, the reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

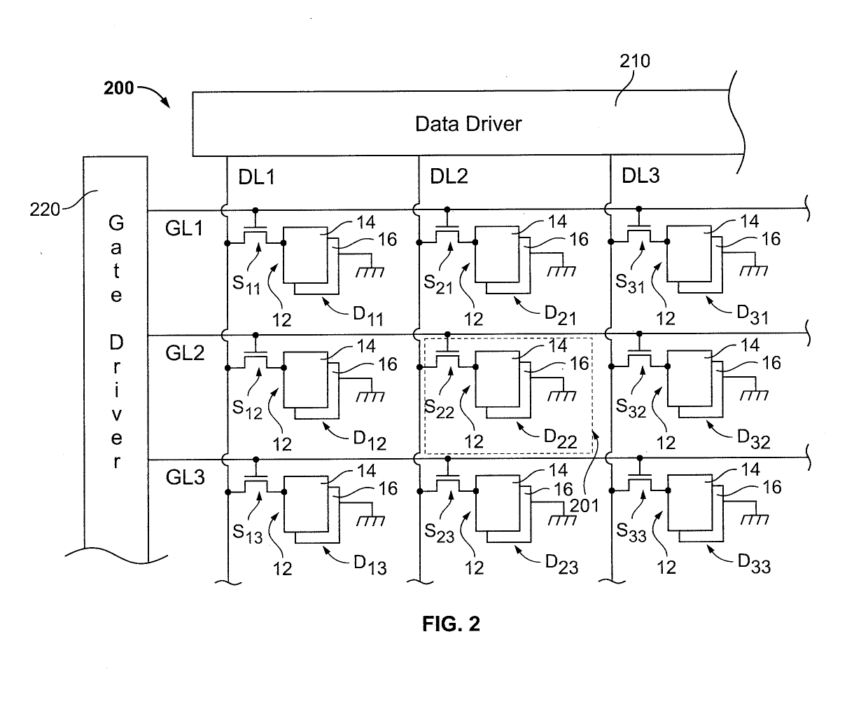

FIG. 2 shows an example of a schematic circuit diagram illustrating a driving circuit array 200 for an optical MEMS display device. The driving circuit array 200 can be used for implementing an active matrix addressing scheme for providing image data to display elements D₁₁-Dₘₙ of a display array assembly.

The driving circuit array 200 includes a data driver 210, a gate driver 220, first to m-th data lines DL1-DLm, first to n-th gate lines GL1-GLn, and an array of switches or switching circuits S₁₁-Sₘₙ. Each of the data lines DL1-DLm extends from the data driver 210, and is electrically connected to a respective column of switches S₁₁-S₁ₙ, S₂₁-S₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, . . . , D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙ-Sₘₙ in the selected row are turned on, the image data from the data driver 210 is passed to the selected row of display elements D₁₁-Dₘ₁, D₁₂-Dₘ₂, . . . , D₁ₙ-Dₘₙ.

During operation, the gate driver 220 can provide a voltage signal via one of the gate lines GL1-GLn to the gates of the switches S₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to, e.g., 10-volts (could be positive or negative), and data lines DL that are associated with pixels that are to be released in the row can be set to, e.g., O-volts. Then, the gate line GL for the given row is asserted, turning the switches in that row on, and applying the selected data line voltage to each pixel of that row. This charges and actuates the pixels that have 10-volts applied, and discharges and releases the pixels that have O-volts applied. Then, the switches S₁₁-Sₘₙ can be turned off. The display elements D₁₁-Dₘ₁, D₁₂-Dₘ₂, . . . , D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the lower electrode 16 is grounded at each pixel. In some implementations, this may be accomplished by depositing a continuous optical stack 16 onto the substrate and grounding the entire sheet at the periphery of the deposited layers. FIG. 3 is an example of a schematic partial cross-section illustrating one implementation of the structure of the driving circuit and the associated display element of FIG. 2.

FIG. 3 shows an example of a schematic partial cross-section illustrating one implementation of the structure of the driving circuit and the associated display element of FIG. 2. The portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable electrode 14/34 supported by the supports 18, and an interconnect 126 electrically connecting the movable electrode 14/34 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

As shown in FIG. 3, the display element D₂₂ can be an interferometric modulator that has a first terminal coupled to the transistor 80, and a second terminal coupled to a common electrode that can be formed by at least part of an optical stack 16. The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display.

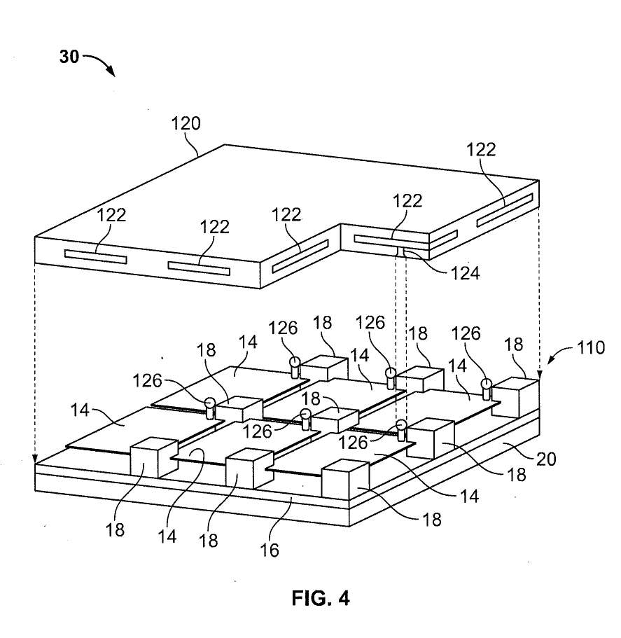

FIG. 4 shows an example of an exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, movable electrodes 14, and interconnects 126. The backplate 120 includes backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The movable electrodes 14/34 can be separate plates having, e.g., a square or rectangular shape. The movable electrodes 14/34 can be arranged in a matrix form such that each of the movable electrodes 14/34 can form part of a display element. In the implementation of FIG. 4, the movable electrodes 14/34 are supported by the supports 18 at four corners.

Each of the interconnects 126 of the display array assembly 110 serves to electrically couple a respective one of the movable electrodes 14/34 to one or more backplate components 122. In the illustrated implementation, the interconnects 126 of the display array assembly 110 extend from the movable electrodes 14/34, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend to and electrically connect to the movable electrodes 14 without actual attachment to the movable electrodes 14, such as the interconnects 126 of FIG. 4.

In addition to the bistable interferometric modulators described above, which have a relaxed state and an actuated state, interferometric modulators may be designed to have a plurality of states. For example, an analog interferometric modulator (AIMOD) may have a range of color states. In one AIMOD implementation, a single interferometric modulator can be actuated into, e.g., a red state, a green state, a blue state, a black state, or a white state. Accordingly, a single interferometric modulator may be configured to have various states with different light reflectance properties over a wide range of the optical spectrum. The optical stack of an AIMOD may differ from the bi-stable display elements described above. These differences may produce different optical results. For example, in the bi-stable elements described above, the closed state gives the bi-stable element a black reflective state. An analog interferometric modulator, however, may have a white reflective state when the electrodes are in a similar position to the closed state of the bi-stable element.

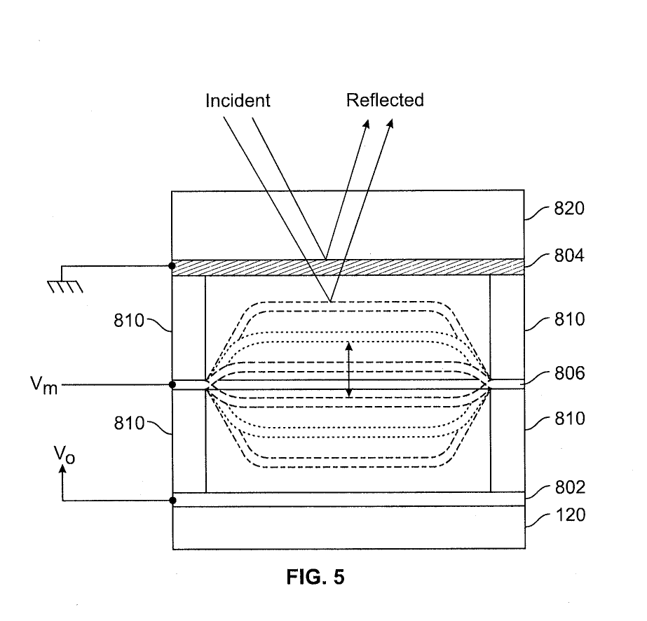

FIG. 5 shows a cross-section of an interferometric modulator having two fixed layers and a movable third layer. Specifically, FIG. 5 shows an implementation of an analog interferometric modulator having a fixed first layer 802, a fixed second layer 804, and a movable third layer 806 positioned between the fixed first and second layers 802 and 804. Each of the layers 802, 804, and 806 may include an electrode or other conductive material. For example, the first layer 802 may include a plate made of metal. Each of the layers 802, 804, and 806 may be stiffened using a stiffening layer formed on or deposited on the respective layer. In one implementation, the stiffening layer includes a dielectric. The stiffening layer may be used to keep the layer to which it is attached rigid and substantially flat. Some implementations of the modulator 800 may be referred to as a three-terminal interferometric modulator.

The three layers 802, 804, and 806 are electrically insulated by insulating posts 810. The movable third layer 806 is suspended from the insulating posts 810. The movable third layer 806 is configured to deform such that the movable third layer 806 may be displaced in a generally upward direction toward the first layer 802, or may be displaced in a generally downward direction toward to the second layer 804. In some implementations, the first layer 802 also may be referred to as the top layer or top electrode. In some implementations, the second layer 804 also may be referred to as the bottom layer or bottom electrode. The interferometric modulator 800 may be supported by a substrate 820.

In FIG. 5, the movable third layer 806 is illustrated as being in an equilibrium position with the solid lines. As illustrated in FIG. 5, a fixed voltage difference may be applied between the first layer 802 and the second layer 804. In this implementation, a voltage V₀ is applied to layer 802 and layer 804 is grounded. If a variable voltage Vₘ is applied to the movable third layer 806, then as that voltage Vₘ approaches V₀, the movable third layer 806 will be electrostatically pulled toward grounded layer 804. As that voltage Vₘ approaches ground, the movable third layer 806 will be electrostatically pulled toward layer 802. If a voltage at the midpoint of these two voltages (V₀/2 in this implementation) is applied to movable third layer 806, then the movable third layer 806 will be maintained in its equilibrium position indicated with solid lines in FIG. 5. By applying a variable voltage to the movable third layer 806 that is between the voltages on the outer layers 802 and 804, the movable third layer 806 can be positioned at a desired location between the outer layers 802 and 804, producing a desired optical response. The voltage difference V₀ between the outer layers can vary widely depending on the materials and construction of the device, and in many implementations may be in the range of about 5-20 volts. It also may be noted that as the movable third layer 806 moves away from this equilibrium position, it will deform or bend. In such deformed or bent configuration, an elastic spring force mechanically biases the movable third layer 806 toward the equilibrium position. This mechanical force also contributes to the final position of the movable third layer 806 when a voltage V is applied there.

The movable third layer 806 may include a mirror to reflect light entering the interferometric modulator 800 through substrate 820. The mirror may include a metal material. The second layer 804 may include a partially absorbing material such that the second layer 804 acts as an absorbing layer. When light reflected from the mirror is viewed from the side of the substrate 820, the viewer may perceive the reflected light as a certain color. By adjusting the position of the movable third layer 806, certain wavelengths of light may be selectively reflected.

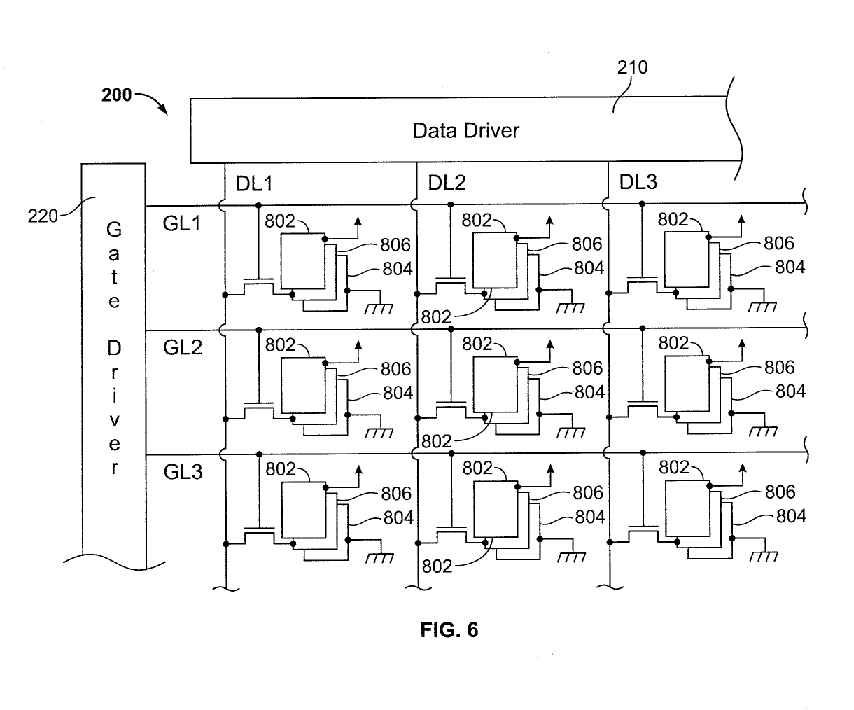

FIG. 6 shows an example of a schematic circuit diagram illustrating a driving circuit array for an optical EMS display device having the structure of FIG. 5. The overall apparatus shares many similarities to the structure of FIG. 2 that uses the bistable interferometric modulators. As shown in FIG. 6, however, an additional upper layer 802 is provided for each display element. This upper layer 802 may be deposited on the underside of the backplate 120 shown in FIGS. 3 and 4, and may have a voltage V₀ applied thereto. These implementations are driven in a manner similar to that described above with reference to FIG. 2, except the voltages provided on the data lines DL1-DLn can be placed at a range of voltages between V₀ and ground, rather than at one of only two different voltages. In this way, the movable third layers 806 of the display elements along a row each can be independently placed in any particular desired position between the upper and lower layers when the row is written by asserting the gate line for that particular row.

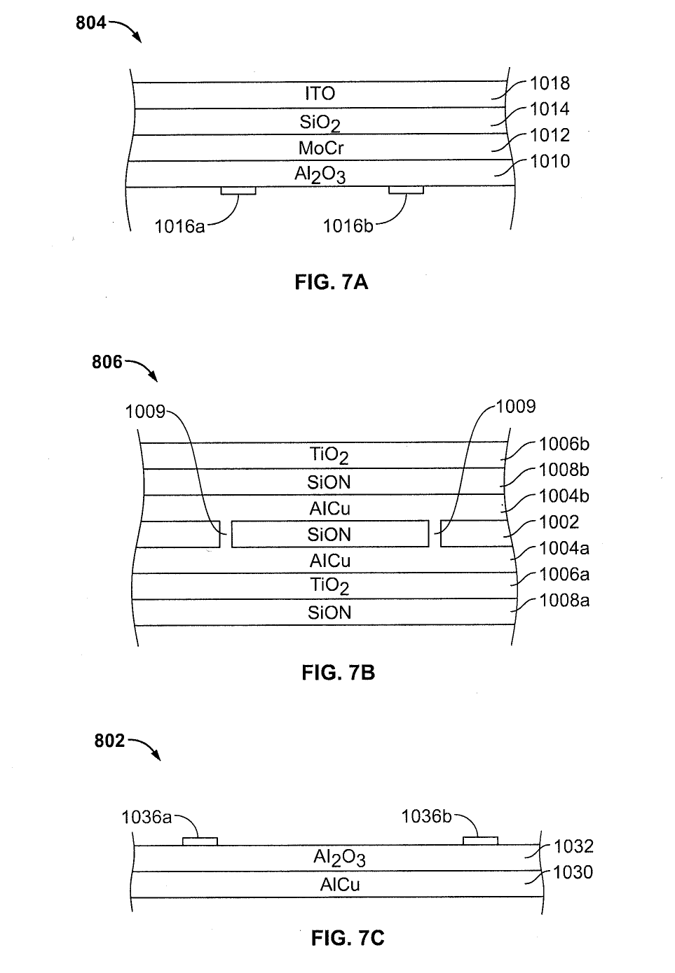

FIGS. 7A-7C show cross-sections of the two fixed layers and the movable layer of the interferometric modulator of FIG. 5 illustrating stacks of materials.

In the implementation illustrated in FIGS. 7A and 7B, the movable third layer 806 and the second layer 804 each include a stack of materials. For example, the movable third layer 806 includes a stack including silicon oxynitride (SiON), aluminum-copper (AlCu), and titanium dioxide (TiO₂). The second layer 804, for example, includes a stack including silicon oxynitride (SiON), aluminum oxide (Al₂O₃), molybdenum-chromium (MoCr), and silicon dioxide (SiO2).

In the illustrated implementation, the movable third layer 806 includes a SiON substrate 1002 having an AlCu layer 1004a deposited thereon. In this implementation, the AlCu layer 1004a is conductive and may be used as an electrode. In some implementations, the AlCu layer 1004 provides reflectivity for light incident thereon. In some implementations, the SiON substrate 1002 is approximately 500 nm thick, and the AlCu layer 1004a is approximately 50 nm thick. A TiO₂ layer 1006a is deposited on the AlCu layer 1004a, and in some implementations the TiO₂ layer 1006a is approximately 26 nm thick. An SiON layer 1008a is deposited on the TiO₂ layer 1006a, and in some implementations the SiON layer 1008a is approximately 52 m thick. The refractive index of the TiO₂ layer 1006a is greater than the refractive index of the SiON layer 1008a. Forming a stack of materials with alternating high and low refractive indices in this way may cause light incident on the stack to be reflected, thereby acting substantially as a mirror.

As can be seen in FIG. 7B, the movable third layer 806 may in some implementations include an additional AlCu layer 1004b, an additional TiO₂ layer 1006b, and an additional SiON layer 1008b formed on the side of the SiON substrate 1002 opposite the AlCu layer 1004a, TiO₂ layer 1006a, and SiON layer 1008a. Forming the layers 1004b, 1006b, and 1008b may weight the movable third layer 806 approximately equally on each side of the SiON substrate 1002, which may increase the positional accuracy and stability of the movable third layer 806 when translating the movable third layer 806. In such implementations, a via 1009 or other electrical connection may be formed between the AlCu layers 1004a and 1004b such that the voltage of the two AlCu layers 1004a and 1004b will remain substantially equal. In this way, when a voltage is applied to one of these two layers, the other of these two layers will receive the same voltage. Additional vias (not shown) may be formed between the AlCu layers 1004a and 1004b.

In the implementation illustrated in FIG. 7A, the second layer 804 includes a SiO₂ substrate 1010 having an MoCr layer 1012 formed thereon. In this implementation, the MoCr layer 1012 may act as a discharge layer to discharge accumulated charge, and may be coupled to a transistor to selectively effect the discharge. The MoCr layer 1012 also may serve as an optical absorber. In some implementations, the MoCr layer 1012 is approximately 5 nm thick. An Al₂O₃ layer 1014 is formed on the MoCr layer 1012, and may provide some reflectance of light incident thereon and may also serve as a bussing layer in some implementations. In some implementations, the Al₂O₃ layer 1014 is approximately 9 nm thick. One or more SiON stops 1016a and 1016b may be formed on the surface of the Al₂O₃ layer 1014. These stops 1016 mechanically prevent the movable third layer 806 from contacting the Al₂O₃ layer 1014 of the second layer 804 when the movable third layer 806 is deflected fully towards the second layer 804. This may reduce stiction and snap-in of the device. Further, an electrode layer 1018 may be formed on the SiO₂ substrate 1010, as shown in FIG. 7. The electrode layer 1018 may include any number of substantially transparent electrically conductive materials, with indium tin oxide being one suitable material.

Layer 802 illustrated in FIG. 7C can be made with simple structure as it has few optical and mechanical requirements it must fulfill. This layer may include a conductive layer of AlCu 1030 and an insulating Al₂O₃ layer 1032. As with layer 804, one or more SiON stops 1036a and 1036b may be formed on the surface of the Al₂O₃ layer 1032.

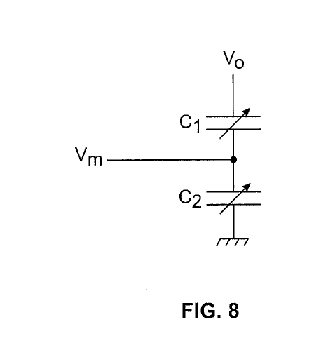

FIG. 8 shows a schematic representation of the interferometric modulator and voltage sources illustrated in FIG. 5. In this schematic, the modulator is coupled to the voltage sources V₀ and Vₘ. Those of skill in the art will appreciate that the gap between the first layer 802 and the movable third layer 806 forms a capacitor C₁ having a variable capacitance, while the gap between the movable third layer 806 and the second layer 804 forms a capacitor C₂ also having a variable capacitance. Thus, in the schematic representation illustrated in FIG. 8, the voltage source V₀ is connected across the series coupled variable capacitors C₁ and C₂, while the voltage source Vₘ is connected between the two variable capacitors C₁ and C₂.

Accurately driving the movable third layer 806 to different positions using the voltage sources V₀ and Vₘ as described above, however, may be difficult with many configurations of the interferometric modulator 800 because the relationship between voltage applied to the interferometric modulator 800 and the position of the movable third layer 806 may be highly non-linear. Further, applying the same voltage Vₘ to the movable layers of different interferometric modulators may not cause the respective movable layers to move to the same position relative to the top and bottom layers of each modulator due to manufacturing differences, for example, variations in thickness or elasticity of the middle layers 806 over the entire display surface. As the position of the movable layer will determine what color is reflected from the interferometric modulator, as discussed above, it is advantageous to be able to detect the position of the movable layer and to accurately drive the movable layer to desired positions.

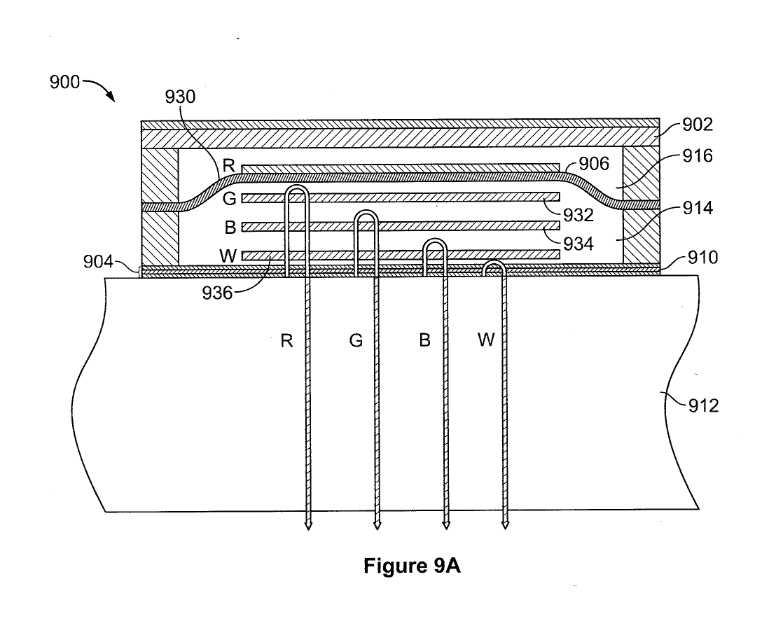

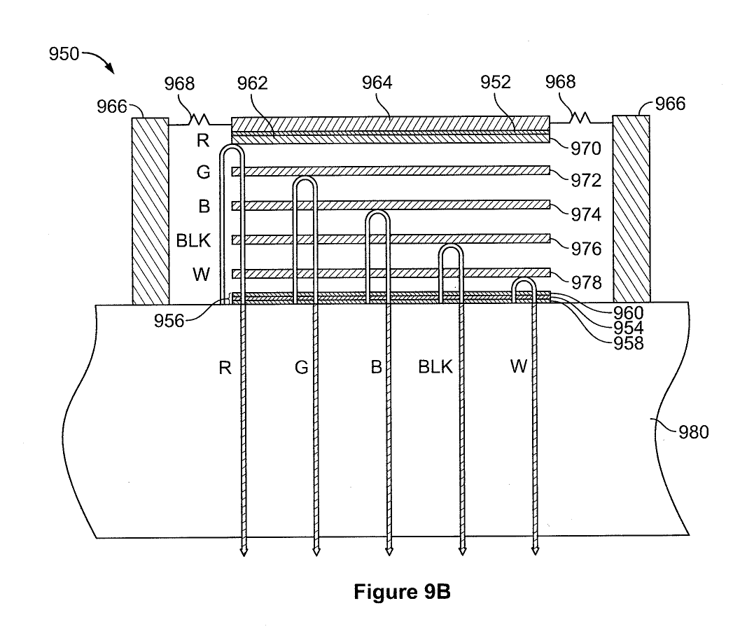

FIGS. 9A and 9B show examples of a cross-section of an analog IMOD (AIMOD). With reference to FIG. 9A, the AIMOD 900 includes a substrate 912 and an optical stack 904 disposed over the substrate 912. The AIMOD includes a first electrode 910 and a second electrode 902 (as illustrated, the first electrode 910 is a lower electrode, and second electrode 902 is an upper electrode). The AIMOD 900 also includes a movable reflective layer 906 disposed between the first electrode 910 and the second electrode 902. In some implementations, the optical stack 904 includes an absorbing layer, and/or a plurality of other layers. In some implementations, and in the example illustrated in FIG. 9A, the optical stack 904 includes the first electrode 910 which is configured as an absorbing layer. In such a configuration, the absorbing layer (first electrode 910) can be an approximately 6 nm layer of material that includes MoCr. In some implementations, the absorbing layer (i.e., the first electrode 910) can be a layer of material including MoCr with a thickness ranging from approximately 2 nm to 10 nm.

Still referring to FIG. 9A, the reflective layer 906 can be provided with a charge. The reflective layer is configured to, once charged, move toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 9A illustrates that the reflective layer 906 can be moved to various positions 930, 932 and 934 and 936 between the first electrode 910 and the second electrode 902.

The AIMOD 900 can be configured to selectively reflect certain wavelengths of light depending on the configuration of the AIMOD. The distance between the first electrode 910, which in this implementation acts as an absorbing layer, and the reflective layer 906 changes the reflective properties of the AIMOD 900. Any particular wavelength is maximally reflected from the AIMOD 900 when the distance between the reflective layer 906 and the absorbing layer (first electrode 910) is such that the absorbing layer (first electrode 910) is located at the minimum light intensity of standing waves resulting from interference between incident light and light reflected from the reflective layer 906. For example, as illustrated, the AIMOD 900 is designed to be viewed from the substrate 912 side of the AIMOD (through the substrate 912), i.e., light enters the AIMOD 900 through the substrate 912. Depending on the position of the reflective layer 906, different wavelengths of light are reflected back through the substrate 912, which gives the appearance of different colors. These different colors are also known as native colors.

A position of a movable layer(s) of a display element (e.g., an AIMOD) at a location such that it reflects a certain wavelength or wavelengths can be referred to a display state. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are substantially reflected such that and the AIMOD 900 appears “grey” or in some cases “silver,” and having low total reflection (or luminance) when a bare metal reflector is used. In some cases increased total reflection (or luminance) can be achieved with the addition of dielectric layers disposed on the metal reflector, but the reflected color may be tinted with blue, green or yellow, depending on the exact position of 936. In some implementations, in position 936, configured to produce a white state, the distance between the reflective layer 906 and the first electrode 910 is between about 0 and 20 nm. It should be noted that one of ordinary skill in the art will readily recognize that the AIMOD 900 can take on different states and selectively reflect other wavelengths of light based on the position of the reflective layer 906, and also based on materials that are used in construction of the AIMOD 900, particularly various layers in the optical stack 904.

The AIMOD 900 in FIG. 9A has two structural cavities, a first cavity 914 between the reflective layer 906 and the optical stack 904, and a second cavity 916 between the reflective layer 906 and the second electrode 902. However, because the reflective layer 906 is reflective and not transmissive, light does not propagate through the reflective layer 906 into the second cavity 916. In addition, the color and/or intensity of light reflected by the AIMOD 900 is determined by the distance between the reflective layer 906 and the absorbing layer (first electrode 910). Accordingly, the AIMOD 900 illustrated in FIG. 9A has one interferometric (absorbing) cavity 914. In contrast, the second cavity 916 is not interferometric.

FIG. 9B shows an example of a cross-section of an analog IMOD (AIMOD) according to another implementation. The AIMOD 950 includes a reflective layer 952 positioned above a first electrode 954 that is also an absorbing layer in an optical stack 956, which can include dielectric layers 958 and 960 positioned over and beneath the first electrode 954. 958 can include more than one layer; likewise, 960 also can include more than one layer. In some implementations, and in the example illustrated in FIG. 9B, the reflective layer 952 can function as a second electrode. In some other implementations, a separate electrode structure may be formed under or over the reflective layer 952. In some implementations, the reflective layer 952 can include aluminum (Al). In some other implementations, different reflective materials may be used. The optical stack 956 also can include an absorbing layer that is not an electrode, and/or a plurality of other layers. In some implementations, and in the example illustrated in FIG. 9B, the first electrode 954 is configured as the absorbing layer. The absorbing layer can be, for example, a 6 nm layer of material that includes MoCr. The reflective layer 952 may be covered with one or more dielectric layers 962 positioned between the reflective layer 952 and the optical stack 956. The function of the dielectric layer 962 is to establish the first null of the standing wave in the cavity about 0-20 nm from the surface of the dielectric layer 962. The dielectric layer 962 is also designed to reduce the separations of the first nulls of different wavelengths for improving the brightness of the white state. The reflective layer 952 can be mounted onto a mechanical layer 964, which is in turn attached to hinges 968. The hinges 968 are in turn connected to posts 966 on either side of the mechanical layer 964. The hinges 968 provide support for the mechanical layer 964, reflective layer 952 and the dielectric layer 962, while still permitting movement of these layers in response to an applied voltage between the first electrode 954 and reflective layer 952, which may serve as a second electrode 952.

With continuing reference to FIG. 9B, the reflective layer 952 can be provided with a charge. The reflective layer is configured to, once charged, move toward the first electrode 954 that is connected to ground. In this manner, the reflective layer 952 can be driven through a range of positions relative to the first electrode 954. For example, FIG. 9B illustrates the reflective layer 952 can be moved to various positions 970, 972, 974, 976 and 978 relative to the first electrode 954.

As discussed with respect to FIG. 9A, the AIMOD 950 can be configured to selectively reflect certain wavelengths of light depending on the configuration of the AIMOD. The distance between the first electrode 954, which in this implementations acts as an absorbing layer, and the reflective layer 952 changes the reflective properties of the AIMOD 950. Any particular wavelength can be maximally reflected by controlling the distance between the reflective layer 952 and the absorbing layer first electrode 954. A high percentage of reflection, or a maximum reflection, can occur when the distance is such that the light reflected off the top surface of the reflective layer 952 interferes constructively within the gap between the reflective layer 952 and the absorbing layer. At this distance, the absorbing layer (first electrode 954) is located at the minimum light intensity of the interference standing waves.

For example, the AIMOD 950 of FIG. 9B is designed to be viewed on the substrate 980 side of the AIMOD. Light enters the AIMOD 950 through the substrate 980. Depending on the position of the reflective layer 952, different wavelengths of light are reflected back through the substrate 980, which gives the appearance of different colors. These different colors are also known as native colors. A position of a movable layer of a display element (e.g., an AIMOD) at a location such that it reflects a certain wavelength or wavelengths can be referred to a display state. For example, when the reflective layer 952 is in position 970, red wavelengths of light are substantially reflected and other wavelengths of light are substantially absorbed by the first electrode 954 (the absorbing layer). Accordingly, the AIMOD 950 appears red and is said to be in a red state or a red display state. Similarly, the AIMOD 950 is in a green display state (or green state) when the reflective layer 952 moves to position 972, where green wavelengths of light are substantially reflected and other wavelengths of light are substantially absorbed. When the reflective layer 952 moves to position 974, the AIMOD 950 is in a blue display state (or blue state) and blue wavelengths of light are substantially reflected and other wavelengths of light are substantially absorbed. When the reflective layer 952 moves to a position 976, the AIMOD 950 is in a black display state (or black state) and a broad range of wavelengths of light in the visible spectrum are substantially absorbed, and visible reflections are thereby minimized, such that the AIMOD 950 appears “black.” When the reflective layer 952 moves to a position 978, the AIMOD 950 is in a white display state (or white state) and a broad range of wavelengths of light in the visible spectrum are substantially reflected such that and the AIMOD 950 appears “white.” In some implementations, in position 978, configured to produce a white state, the distance between the reflective layer 952 and the first electrode 954 is between about 0 and 20 nm.

In an IMOD display element, the display element's reflective color is determined by the gap spacing between the thin absorbing metal layer and a mirror surface. To produce a white appearance with high brightness, reflections of all wavelengths in the visible spectrum is desired. To achieve high brightness, an optical reflector can be used that includes a metal layer (e.g., 952 in FIG. 9B) and one or more dielectric layers (e.g., 962 in FIG. 9B) disposed on the metal layer. In this scheme, the first null of the interference standing wave is found in the cavity near the reflector surface. In the white state, the reflector is moved in close proximity to the absorber (in the range of 0-20 nm) such that the absorber is located at the null of the standing wave. One problem, however, is that the locations of the nulls of different wavelengths are not exactly the same; therefore the required spacing for maximum reflection is different for different wavelengths. The optimum spacing that reflects both the short wavelength (blue) and long wavelength (red) is a spacing somewhere in the middle. As a result, the white state of many AIMODs may produce a white with greenish tint. In other words, green is reflected more strongly from the AIMOD than red or blue, resulting in an imperfect white appearance. It will be understood that although greenish tint is common, other configurations produce a white state with a bluish tint or yellowish tint, and other similar deviations from true white are possible. Existing solutions to this problem involve a pixel dithering technique that mixes the tinted white with other colors to synthesize a more true white. This approach, however, can reduce luminance, sacrifice spatial resolution and consume additional processing and electric power.

To address this problem, a color notch filter can be employed to modify the reflected color of the AIMOD in order to minimize the greenish tint. An aim is to minimize the difference between the reflected spectrum of the white state with that of illuminant D65, an industry standard power spectrum of white color for electronic displays, e.g., an LCD display. Although any suitable type of color notch filter may be used, the configuration of such a filter is such that it specifically filters the wavelengths desired for such AIMOD display elements. The notch filter can include, but is not limited to, a filter including thin film dyes, metal nanoparticles, Rugate filters, holograph notch filters, or any other technology that allows for selective filtering to achieve the desired amount of power of a specific spectrum.

To provide for consistency of color in a display comprised of a plurality of IMODs, precise positioning of the moveable layer 906, in FIG. 9A for example, to provide for each color displayed may be desirable. Due to variations in the manufacturing process of the analog IMOD design 900, the position of the moveable layer 906 at a given voltage may vary across a plurality of IMODs. For example, the mechanical resistance of moveable layer 906 may vary slightly for each IMOD. Also, the voltage difference between moveable layer 906 of FIG. 9A and first electrode 910 and the second electrode 902 may also vary slightly due to, for example, the distance of the AIMOD from a voltage source. In some aspects, this difference may be due to voltage loses from electrical leads connecting the IMOD 900 to the voltage source.

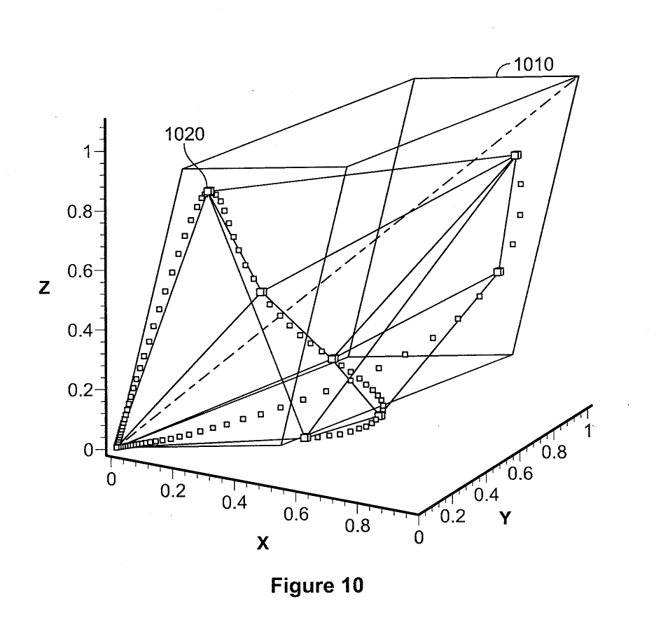

FIG. 10 illustrates a color space with superimposed color gamuts for a RGB parallelpiped 1010 and an analog IMOD 1020. In some implementations, the color gamut for the analog IMOD 1020 may be produced by the interferometric modulator illustrated in FIG. 9A or FIG. 9B. As can be seen in FIG. 10, the color gamut outlined by the RGB parallelepiped 1010 is large and continuous within the illustrated three dimensional color space. A color system based on an RGB color mapping can reproduce the virtually contiguous area within the parallelepiped 1010. In contrast, the non-contiguous spiral color gamut 1020 produced by the analog IMOD, while including individual samples of many colors within the color space, consists only of discrete points of color. As discussed previously, each of these individual points of color produced by the analog IMOD is produced at a particular position of the reflective layer 906 described in FIG. 9A or moveable layer 952 of FIG. 9B. However, as illustrated in FIG. 10, the non-contiguous color spiral 1020 produced by an analog IMOD can omit certain areas of color from its displayable color gamut.

One method to address this situation is to use bi-stable IMODs as subpixels within a display. Each subpixel IMOD may then be configured to display a particular color, for example red, green, or blue. The colors reflected from these three subpixels are then combined into a colored pixel, as is done with a traditional RGB display. With this display architecture, a traditional RGB color mapping can be employed to reproduce the RGB color gamut as illustrated by the RGB parallelepiped 1010 of FIG. 10. However, such a display architecture does not incorporate certain features that are provided by analog IMOD technology. For example, an analog IMOD is capable of producing more than two colors. By taking advantage of this capability, analog IMODs used in color displays have the potential to reduce display size, cost, and weight, when compared to traditional two color only technologies such as LCD or LEDs.

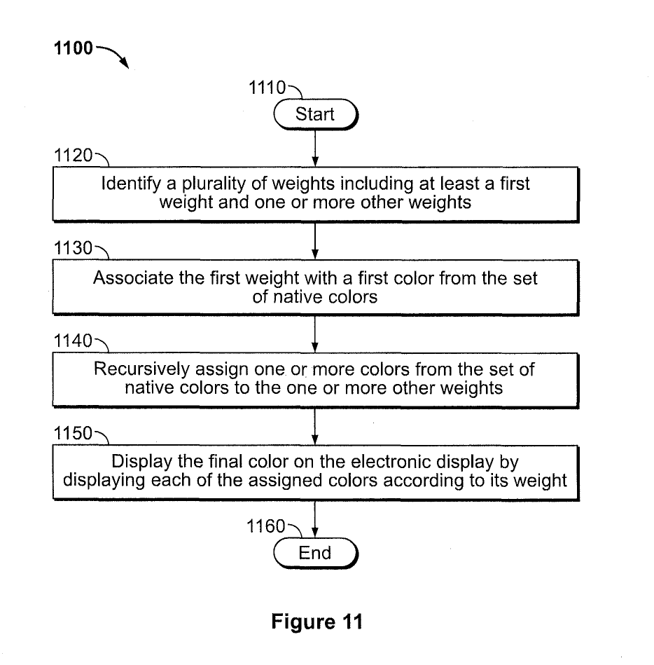

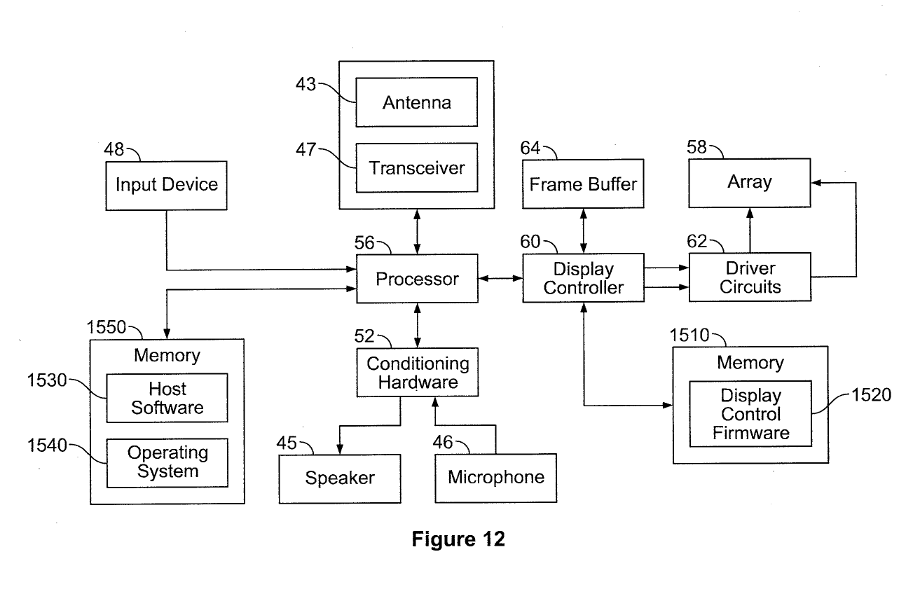

FIG. 11 is a flowchart illustrating one operative implementation of a method of displaying a final color on an electronic display that is capable of displaying a set of native colors. The “final color” refers to a color that a viewer of the display visually perceives. This final or perceived color may include one or more native colors displayed by one or more display devices (for example, analog IMODs). These native colors may be temporally modulated or spatially modulated to produce the final color perceived by the viewer. Process 1100 begins at start block 1110 and then moves to block 1120, where a plurality of weights including at least a first weight and one or more other weights are identified. Block 1120 may be performed in some implementations by instructions included in operating system 1240, host software 1230, or display control firmware 1220, described below with respect to FIG. 12.

The weights identified in block 1120 may vary by implementation. For example, some implementations may use a plurality of weights that are proportional to Wᵢ=1/Bⁱ, where B is the base of the weighting system. The base of the weighting system may be base 2 (B=2), base 3, or base 4 for example. “i” may be the ordinal position of the weight in the plurality of weights. “i” may also represent the order in which the weights are associated with native colors in block 1130 (discussed below). In some other implementations, each weight may be repeated one or more times in the series of weights before the next weight in the series is associated with a color.

Some other implementations may identify a plurality of weights that are proportional to a series defined by Wᵢ=1/B (1-1/B)ⁱ, where Wᵢ is a weight or is proportional to a weight. “B” is the base of the series and may vary by implementation, but may be 2, 3, 4, 5, 6, 7, 8, or 9. “i” may include values from 0 to the number of weights −1 in these implementations.

Some other implementations may identify a plurality of weights based on a Fibonacci sequence. For example, the weight may be proportional to the sequence 34, 21, 13, 8, 5, 3, 2, 1, 1. The squares of Fibonacci numbers may also be used in some implementations.

For purposes of the discussion of process 1100, we will assume the illustrated implementation identifies a plurality of weights defined by the series Wᵢ=1/Bⁱ, where B=2. Therefore, in this example implementation, the weights, are ¼, ⅛, 1/16, etc.

Process 1100 then moves to block 1130, where the first weight is associated with a first color from the set of native colors. In one implementation, the set of native colors will include each color capable of being produced by an analog IMOD. For example, in the analog IMOD illustrated in FIG. 9A, each position of electrode 906, including illustrated positions 930, 932, 934, and 936, may produce one native color. Therefore, the set of native colors may include the four colors produced at positions 930, 932, 934, and 936.

For example, in this example, the color produced by electrode position 930 of FIG. 9A may be associated with the weight of 0.25. Block 1130 may be performed by instructions included in operating system 1240, host software 1230, or display control firmware 1220, all described below with respect to FIG. 12.

Process 1100 then moves to block 1140, where one or more colors are recursively assigned to the one or more other weights. In the illustrated example, the color associated with electrode position 932 may be assigned to another weight, for example, a weight of ⅛ or 0.125. The color associated with electrode positions 934 may also be associated with a weight, for example, 1/16 or 0.0625. Note that not all of the colors in the set of native colors are necessarily associated with a weight. Additionally, the same native color from the set of native colors may be associated with more than one weight. For example, the color produced when the electrode 906 is in position 930, while associated with a weight of 0.25, may also be associated with a weight of ⅛ or 0.125. The recursive association described by block 1140 may occur for any finite number of weights and colors. For example, three, four, five, six, seven, eight, nine, ten, twenty, fifty, or one hundred associations may be made. Block 1140 may be performed by instructions included in operating system 1240, host software 1230, or display control firmware 1220, all described below with respect to FIG. 12.

Process 1100 then moves to block 1150, where the final color is displayed on a display by displaying each of the assigned colors according to its weight. Block 1150 may be performed by instructions included in operating system 1240, host software 1230, or display control firmware 1220, all described below with respect to FIG. 12.

In some implementations, the colors associated in blocks 1130 and 1140 are displayed on a particular analog IMOD. For example, the first color may be displayed on a particular analog IMOD for a time period proportional to its weight. After that time period expires, a second native color may be displayed on the same analog IMOD for another time period proportional to the weight the second color was assigned. Referring back to the previous example's colors and weights, the color associated with electrode position 930 may be displayed for 0.25t, where t is a time quantum. The color associated with electrode 906 position 934 may then be displayed for a time period ⅛t or 0.125t, per the example above. This method of display is a temporal modulation technique, where separate discrete time periods are used to modulate the associated colors.

In other implementations, colors in the set of native colors may be displayed on separate display elements, for example, analog IMOD devices. In such implementations, the associated colors may be displayed simultaneously, at least for some period of time. Alternatively, the number of associated colors may share a smaller set of physical IMOD devices. For example, four associated colors may be displayed across two physical IMOD devices. This type of implementation is a type of spatial modulation technique, in that the associated colors are modulated across the visual space occupied by the separate IMOD devices. After the associated colors have been displayed, process 1100 moves to end state 1160.

FIG. 12 is a block diagram illustrating one implementation of an apparatus for displaying a final color on an electronic display where each display element of the display is capable of displaying a set of native colors. The apparatus includes a processor 56 in communication with a memory 1250. The memory 1250 includes host software 1230 and operating system 1240. Processor 56 is also in communication with display controller 60. Display controller 60 is in communication with a frame buffer 64 and a memory 1210. Memory 1210 includes display control firmware 1220.

In some implementations, operating system 1240 manages the resources of the apparatus to accomplish apparatus functions. For example, operating system 1240 may manage resources such as speaker 45 and microphone 46, as well as antenna 43 and transceiver 47. Operating system 1240 may also include display device drivers that manage an electronic display, such as a display controlled by display controller 60. A display device driver within operating system 1240 may include instructions that interpolate native colors of an analog IMOD to produce a desired color.

For example, instructions within operating system 1240 may configure processor 56 to produce a first color from drive instructions for a plurality of display devices. Operating system 1240 may further configure the processor 56 to identify a plurality of weights including at least a first weight and one or more other weights. Therefore, instructions within operating system 1240 may represent one means for producing a first color from drive instructions for a plurality of display devices, and means for identifying a plurality of weights including at least a first weight and one or more other weights.

Instructions within operating system 1240 may also configure processor 56 to associate the first weight with a first color from a set of native colors. Therefore, instructions within operating system 1240 represent one means for associating the first weight with a first color from a set of native colors. Instructions within operating system 1240 may also configure processor 56 to determine an error between the first color and a desired or target color. Therefore, instructions within operating system 1240 represent one means for determining an error between the first color and a desired or target color. Instructions within operating system 1240 may also be a means for diffusing the error by displaying at least another color on at least a portion of the plurality of display devices.

Instructions within operating system 1240 may also configure the processor 56 to recursively assign one or more colors from the set of native colors to the one or more other weights. The instructions may further configure the processor to assign the colors based on the displayed colors and an error normalized by previously assigned weights. Therefore, instructions within operating system 1240 may represent one means for recursively assigning one or more colors from the set of native colors to the one or more other weights. They may further represent the means for recursively assigning one or more colors when each subsequent color is assigned based on the displayed colors and an error normalized by previously assigned weights.

Instructions within operating system 1240 may configure processor 56 to display the final color on an electronic display by displaying each of the assigned colors according to its weight. Therefore, instructions within operating system 1240 may represent one means for displaying a final color on an electronic display by displaying each of the assigned colors according to its weight.

In other implementations, the functions described above as included in operating system 1240 may instead be included in host software 1230, illustrated in FIG. 12. Alternatively, these functions may instead be implemented by instructions included in display control firmware 1220. One having ordinary skill in the art would recognize other implementations may vary from the block diagram of FIG. 12 without departing from the spirit of the methods disclosed.

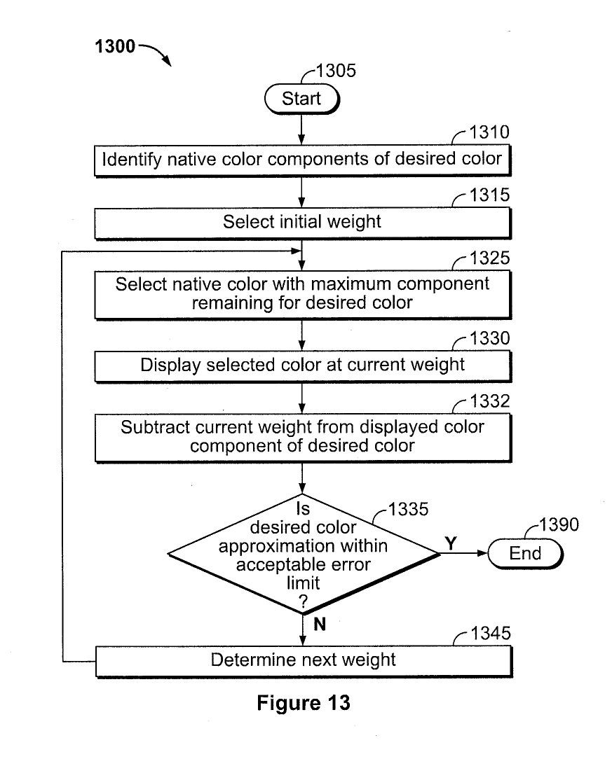

FIG. 13 is a flowchart illustrating another implementation of a method of displaying a final color on an electronic display where each display element of the display is capable of displaying a set of native colors. Process 1300 may be implemented by instructions included in the operating system 1240, host program 1230, or display control firmware 1220 of FIG. 12. Process 1300 begins at start block 1305 and then moves to block 1310 where the native color components of a desired color are identified. In some implementations, the desired color may be mapped to a color region coordinate system with the axes of the color region corresponding to each of the native colors in a set of native colors. Additionally, the sum of each point's coordinates in the coordinate system may be one.

In some embodiments, each available color selected to synthesize a desired color is considered to form a space. These colors then can be represented as unit vectors of this space. While the representation of the colors may not be unit vectors in general, they may be scaled to a value of one (together with the entire space) without loss of generality. Given this, if the desired color lies on a line joining two available colors in the palette (each color represented by a unit vectors), and weights are computed such that the weighted sum of the available colors matches the desired color, then the sum of the weights is one. Likewise, if the desired color lies on a plane joining three available colors, the sum of the three weights is one.

In some embodiments, the sum of the weights may not equal one. Instead, a more relaxed condition may be that the sum of the weights is less than or equal to one. For example, Sigma[wi]≦1. In this embodiment, a “perfect black” may be presumed to be one of the additional colors, and weight “1—Sigma[wi]” may be assigned to this black. When a summation is performed over all the colors in this embodiment, including the new black, the sum will be one. Since the spare color chosen was perfect black, the desired color is not affected by the perfect black.

The above may further be generalized in another embodiment to the case when the newly added color is NOT black but some other color, say C (where C is represented by a vector). This may be performed by subtracting C from all the colors in the entire space before processing, and adding C again after processing. During the processing then, C itself becomes perfectly black after getting subtracted from itself.

In an embodiment, when a color map utilizing a traditional RGB color scheme is used, the coordinate system may include three axes (x, y, z), one each for red, green, and blue. Each value in the N-tuple coordinates of a point representing the desired color may represent a total weight of that native color within the desired color, with the total weights of all the native colors adding to a value of one. When the native colors are added together according to their total weights, the color represented by the N-tuple is produced.

Once the desired color has been mapped to a coordinate system defined by the native colors, process 1300 moves to block 1315, where an initial weight is selected. Process 1300 then moves to block 1325. One implementation of process 1300 may operate by tracking the remaining components of a desired color that have not yet been displayed. When process 1300 starts, the remaining color components are equivalent to the desired color itself, because no colors have been displayed. However, as process 1300 displays native colors, remaining components of the desired color are reduced. In block 1325, the native color with the maximum component remaining to form the desired color may be selected. For example, in a three axis coordinate system such as an RGB (R, G, B) system, with a desired color mapped to coordinates (0.4, 0.3, 0.3), red may be selected in block 1325 (corresponding to the largest “0.4” component of the tuple). Process 1300 then moves to block 1330, where the selected color is displayed at the current weight. Following the previous example, red would be displayed at a weight of 0.3. As described earlier, the method utilized to display a color at a particular weight may vary. For example, some implementations may use a temporal modulation technique to display a color at a particular weight while other implementations may use a spatial modulation technique, as described above.

After the selected color is displayed, process 1300 moves to block 1332. In block 1332, the current weight is subtracted from the recently displayed native color component of the desired color. In the current example, ⅓ would be subtracted from the red component of the desired color's components of (0.4, 0.3, 0.3), resulting in ˜(0.067, 0.3, 0.3). This new tuple does not represent the desired color itself, but instead represents the color components of the desired color remaining to be displayed.

Process 1300 then moves to decision block 1335, where the remaining desired color components are compared against an acceptable error threshold. If the remaining color components of the desired color are smaller than the error threshold, process 1300 moves to end block 1390. If the remaining color components of the desired color are above the error threshold, process 1300 moves to block 1345 where a next weight is determined. In some implementations, the next weight may be determined by Equation 1 below:

xᵢ=x₀*(1−x₀)floor(i/r) (1)

where:
the first weight is represented by x₀,

i is an integer value from 0 to n−1,

n is the number of weights, and

r is a number of times that a value in the set is assigned to the first weight.

Process 1300 then returns to block 1325 and repeats. When it is determined that the desired color approximation is within the acceptable error limit at block 1335, process 1300 ends.

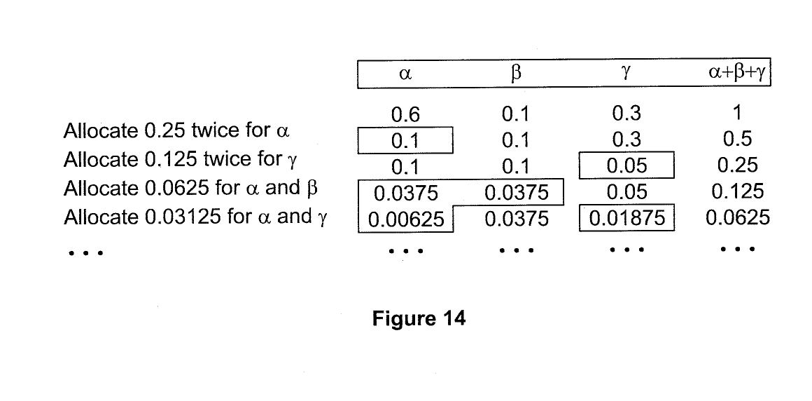

FIG. 14 illustrates how one implementation of a method of displaying a final color on an electronic display capable of displaying a set of native colors may operate. In the illustrated example, the desired color is listed in the top row, with components of α=0.6, β=0.1, and γ=0.3. In this example, an initial weight of 0.25 is chosen. Since the αcomponent is largest, the weight is initially subtracted from it. In this example, each weight is also being repeated twice. After an initial iteration, the α component is 0.6-0.25=0.35, which is still the largest component remaining. Therefore, α would be displayed again, and the weight again subtracted from the α component, resulting in a component of 0.1α remaining. Per Equation 1 (above), this example implementation selects the next weight of 0.125, and selects the color with the largest color component remaining, in this case γ. The color corresponding toy is then displayed. Because each weight is repeating twice in the example implementation, a weight of 0.125 is again applied to the γ component, resulting in a remaining γ component of 0.05. In the next iteration, the next weight is determined based on Equation 1 (above). Both α and β have the largest components remaining, and the new weight is subtracted from the 0.1α and 0.1β components. In the final illustrated iteration, the next weight is selected and subtracted from the γ and α components.

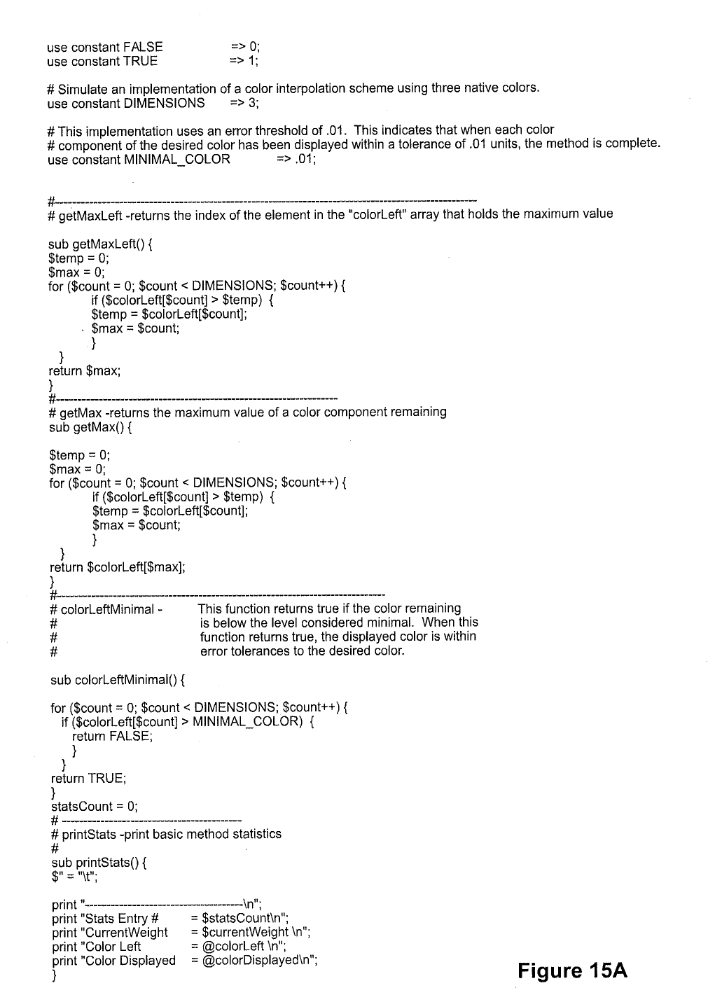

FIGS. 15a, 15b, and 15c illustrate one example implementation of a Perl programming language simulation and output of the method described in FIG. 13 and FIG. 14. FIG. 15a consists primarily of ancillary subroutines used to support the main body, which is shown in FIG. 15b. After initializations, the main body enters a do/until loop that repeats until the difference between the displayed color and the desired color is within an error tolerance. The until condition at the bottom of the code segment of FIG. 15b on line 49 may correspond to decision block 1335 of FIG. 13 in some implementations. The weight used for each iteration is initialized on line 12 of FIG. 15b. While the weight is initialized to the inverse of the number of dimensions, this is just one example of how a weight may be initialized. Other implementations may provide no relationship between the number of native colors and the weights. The initialization of the initial weight on line 12 may correspond to block 1315 of FIG. 13 in some implementations. Selecting a native color with the maximum component remaining for the desired color, as described by block 1325 of FIG. 13, is illustrated on line 23 of FIG. 15b. Block 1332 of FIG. 13 may be implemented by line 31 of FIG. 15b. One implementation of blocks 1340 and 1345 of FIG. 13, which determine whether the current weight should be repeated and if not, determine the next weight, is illustrated by lines 46-48 of FIG. 15b. In the illustrated Perl implementation, the next weight is determined by Equation 1 described above with respect to FIG. 13.

The output of the method implemented by the Perl code of FIGS. 15a and 15b is shown in FIG. 15c. The particular method illustrated determined that each weight would be repeated one time. This information is shown first in the program output. Next, statistics related to successive iterations of the do/until loop of FIG. 15b are shown separated by horizontal lines. Since the main body of the program initially calls the “printStats( )” subroutine, the initial starting conditions are shown in stats entry #1. The current and initial weight begins at ⅓. The “colorLeft” variable is initialized to some arbitrary hardcoded constants of (0.3, 0.4, 0.3). These numbers are meaningful only as an example. Since no color has been displayed (simulated) at statistics entry #1, the “colorDisplayed” array remains zero. Statistics entry #2 illustrates a new weight, and the remaining color components (represented by “ColorLeft” have been reduced. Note the largest component of “ColorLeft” from entry #1 (0.4) has been reduced by the previous weight of entry #1 (⅓). Note also that the color displayed of entry #2 shows it has been incremented by the weight of entry #1. The statistics continue until the remaining color components (of “ColorLeft”) each drop below the error tolerance set in this particular implementation of 0.01, (see the Perl MINIMAL_COLOR constant of FIG. 15a), at which point the do/until loop terminates and the final set of statistics are printed in entry #11. Note the error between the initial value of “ColorLeft” in entry #1, representing the desired color, and the final color, represented by the last value of “ColorDisplayed” in entry #11. The method may be tuned in some implementations to reduce the error between the desired color and the final color, by varying the initial weight, the repeatCount, how each successive weight is calculated, or the MINIMAL_COLOR constant.

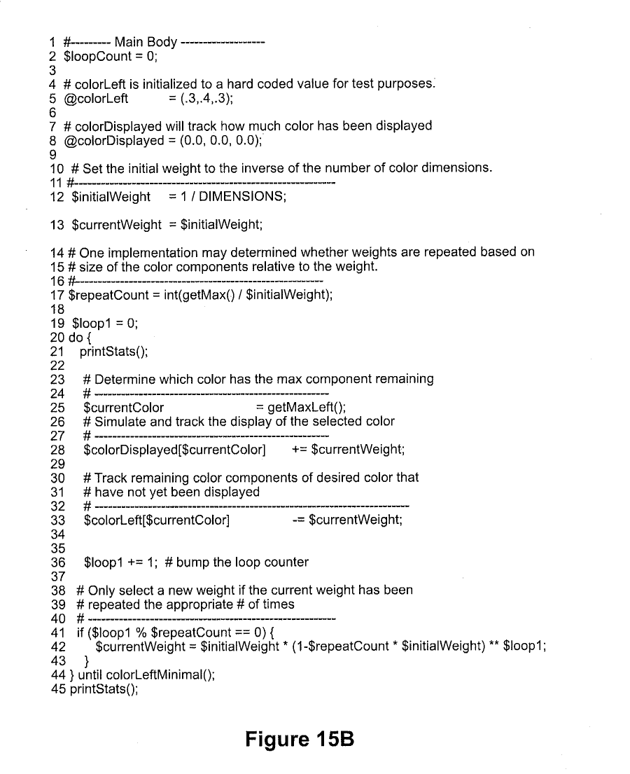

FIG. 16 is a flowchart illustrating another implementation of a method of displaying a final color on an electronic display capable of displaying a set of native colors. Process 1600 may be implemented by instructions included in any of the operating system 1240, host program 1230, or display controller firmware 1220 components, illustrated in FIG. 12.

Process 1600 begins at start block 1610 and then transitions to block 1620, where a plurality of weights including at least a first weight and one or more other weights are identified. Process 1600 then moves to block 1630, where a first color is selected from the set of native colors that is closest to the desired color and then assigned to the first weight. Process 1600 then moves to block 1640, where an error is determined between the first color and the desired color. Process 1600 then moves to block 1650, where instructions recursively assign a subsequent color from the set of native colors to the one or more other weights, and each subsequent color is assigned based on the desired color and an error normalized by previously assigned weights. Process 1600 then moves to block 1660, where each assigned color is displayed according to its weight on the electronic display. As discussed previously, some implementations may use temporal modulation to display colors according to their weights, while some other implementations may use spatial modulation to display colors according to their weights. Process 1600 then moves to end state 1670.

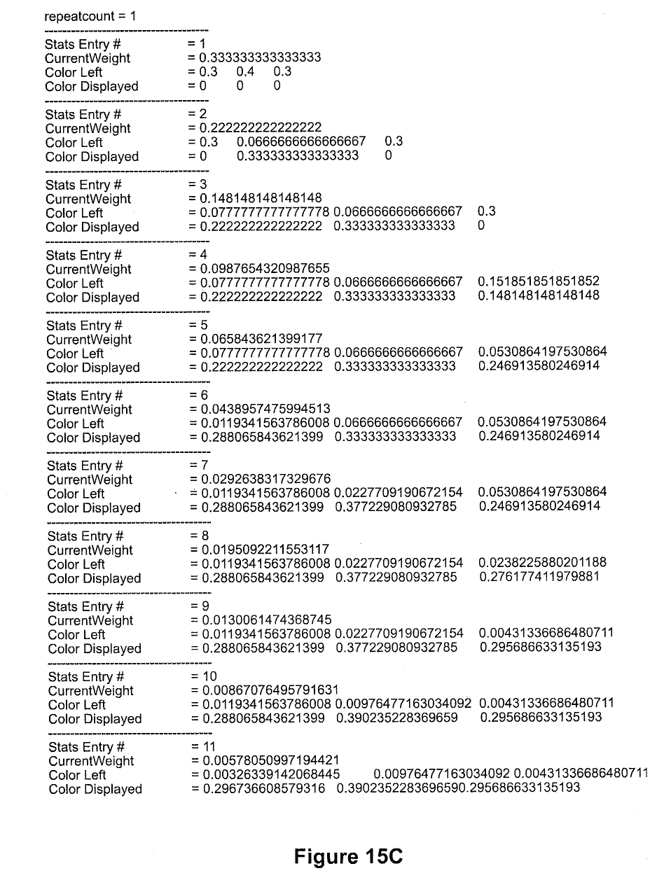

FIG. 17 is a flowchart illustrating another implementation of a method of displaying a final color on an electronic display capable of displaying a set of native colors. Process 1700 may be implemented by instructions contained in the operating system 1240, host program 1230, or display driver firmware 1220 of FIG. 12.

Process 1700 begins at start block 1705 and then transitions to block 1710, where a plurality of weights are identified including at least a first weight and one or more other weights. How an implementation selects weights may vary based on the considerations of that particular implementation. For example, selecting a relatively larger initial weight may minimize the number of iterations process 1700 performs. This may reduce the execution time of process 1700. However, larger weights may result in larger errors between the desired color and an actual/final color resulting from the method. This may result in more iterations in some implementations.

Process 1700 then moves to block 1712, where a “totalWeights” variable is initialized with the sum of the identified weights from block 1710. Process 1700 then moves to block 1715, where a native color nearest to a current target color is selected. When process 1700 first begins, the current target color is initialized to the desired color. As described earlier, in implementations using analog IMODS, the set of native colors mapped to a three dimensional color space such as the one illustrated in FIG. 10 may be described as a non contiguous spiral. A desired color may also be mapped to a similar color space, for example, the three dimensional color space of FIG. 10. In one implementation, the distance from the desired color to the closest color on the IMOD non-contiguous spiral can be determined, and that color selected in block 1715. Similarly, another color, represented by “current target color” in the description of process 1700, may also be mapped to the IMOD color space as described above. Note that while the “current target color” is initialized to the desired color in process 1700, the color represented by “current target color” will change as the method proceeds.

It should also be noted that the desired color and the final color or actual color are not necessarily the same color. While the method disclosed attempts to approximate a desired color, an error may remain between the desired color and the final or actual color perceived by a visual observer when the method is completed. Furthermore, an actual color may be equivalent to the final color when the method completes. However. an “actual color” may have multiple intermediate values as the method proceeds.

Process 1700 then moves to block 1720, where the selected color is displayed at the current weight. As described earlier, temporal or spatial modulation may be used in some implementations to display a particular color at a particular weight. Process 1700 then moves to block 1725, where a “totalColorDisplayed” variable is updated by adding to it the previously selected and displayed color multiplied by the current weight. Process 1700 then moves to block 1735, where the total weight displayed and total weight remaining are tracked. By adding the current weight to the total weight displayed, the color displayed at the current weight in block 1720 is tracked. Since process 1700 calculated the total weight in block 1712, it can now determine the amount of weight remaining to be displayed.

Process 1700 then moves to block 1740, where an error between the displayed color and the current target color is determined. An error variable “E_{i-begin}” is calculated to represent the error. “E_{i-begin}” is calculated by subtracting from the desired color, a weighted sum of the color displayed thus far, divided by the total weight associated with colors displayed thus far. Based on the iterative nature of process 1700, and the calculation of E_{i-begin} in block 1740, the illustrated implementation calculates E_{i-begin} as in Equation 2, below:

$${ɛ}_{i \text{-} begin} = {C}_{Desired} - \frac{{\sum }_{k = 0}^{i - 1} ( {C}_{k} {W}_{k} )}{{\sum }_{k = 0}^{i - 1} ( {W}_{k} )} \qquad ( 2 )$$

where:

C_{Desired} is the desired color

Cₖ is the color displayed at a particular iteration k

Wₖ is the weight at a particular iteration k

Process 1700 then moves to decision block 1745, and determines whether the error is within an acceptable limit. If it is, process 1700 moves to end state 1795. If the error is still above a threshold error limit, process 1700 moves from decision block 1745 to block 1750, where the next weight is determined. In some implementations, the weight may be determined by Equation 1 described above. In some implementations, weights may also be repeated.

Process 1700 then moves to decision block 1755, and determines whether the implementation is using an aggressive color selection algorithm. If the aggressive algorithm is selected, process 1700 moves to block 1760. Block 1760 attempts to set the next “current target color” to be the color that would immediately achieve the desired color if the next color was a native color. One implementation of a method of determining the next color is illustrated by Equation 3 below:

$${C}_{i} = {C}_{Desired} + {ɛ}_{i \text{-} begin} \frac{{\sum }_{k = 0}^{i - 1} ( {W}_{k} )}{{W}_{i}} \qquad ( 3 )$$

where:

Cᵢ is the next color to be displayed

C_{Desired} is the desired color

Cₖ is the color displayed at a particular iteration k

Wₖ is the weight at a particular iteration k

To implement Equation 3 above, block 1760 sets the next color proportion variable to the total WeightDisplayed thus far divided by the current weight. Note that the current weight has been updated in block 1750 and thus reflects the next iteration's weight, as defined by the “Wᵢ” term of Equation 3. The “nextColor Proportion” variable reflects the rightmost term of Equation 3 above.

However, if decision block 1755 determines that a less aggressive color selection algorithm should be used, process 1700 moves to block 1770. Block 1770 establishes a target color that if it was assigned to all remaining weights, it would achieve the desired color. This also assumes the new target color is available as a native color. This method of determining the next color can be illustrated by Equation 4 below:

$${C}_{i} = {C}_{Desired} + {ɛ}_{i \text{-} begin} \frac{{\sum }_{k = 0}^{i - 1} ( {W}_{k} )}{{\sum }_{k = i}^{N - 1} ( {W}_{k} )} \qquad ( 4 )$$

where:

Cᵢ is the next color to be displayed

C_{Desired} is the desired color

Cₖ is the color displayed at a particular iteration k

Wₖ is the weight at a particular iteration k

To implement Equation 4, block 1770 sets the “nextColor Proportion” to the total weight displayed thus far divided by the total weight remaining. This represents the rightmost term of Equation 4 above.

Process 1700 then moves to block 1780, where the currentTargetColor is reset to the desired color+the error “E_{i-begin}” multiplied by the proportion calculated in block 1760 or block 1770, as defined by Equations three and four above. Process 1700 then returns to block 1712 and process 1700 repeats.

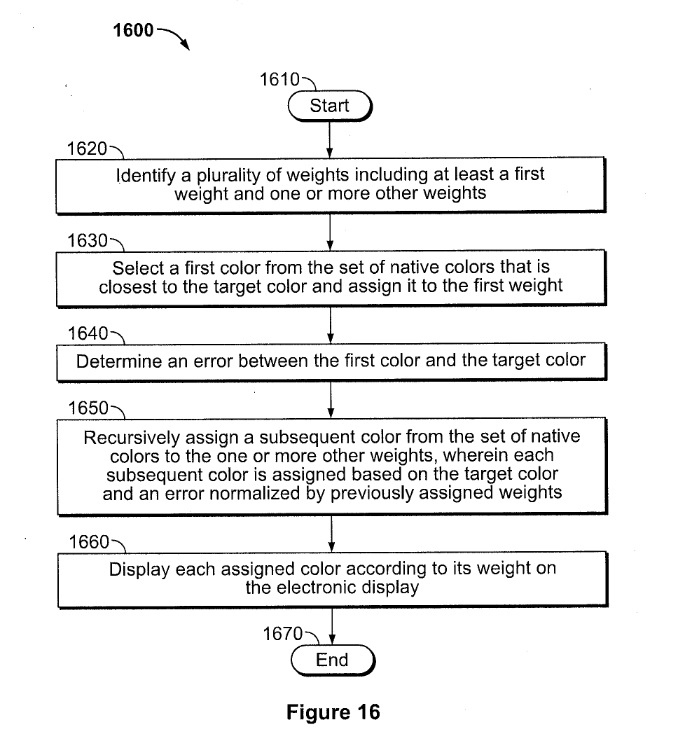

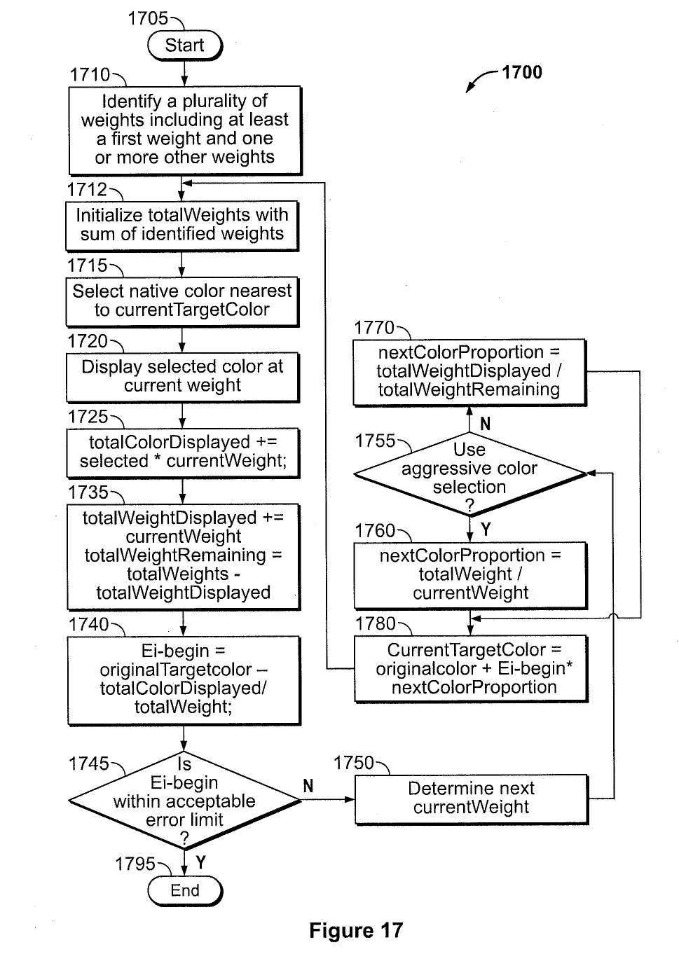

FIG. 18A illustrates one implementation utilizing a plurality of IMODs configured to display different colors that are disposed adjacent to each other. This configuration may mimic a traditional RGB display in some implementations.

FIG. 18B is a data flow diagram of a method for driving the three IMODs of FIG. 18A. Three RGB input values on the left side of the figure are received by the bi-stable IMOD color processing module. Color processing, including any color interpolation, is then performed and output values generated. For example, the RGB input values may be 4, 8, 16, 24, or 32 bits each in some implementations. The bi-stable color processing module may then convert those N bit values into one bit values compatible with the bi-stable IMODs. These one bit values are then output on the right side of the color processing module.

Each of the three bi-stable IMODs are independently addressed in that three separate voltages are then sent from the color processing module to each of the R/G/B IMODs. Each voltage can take one of two values. The combinations of these three voltages generate one out of eight possible color combinations in the RGB pixel that includes the three bi-stable IMODs.

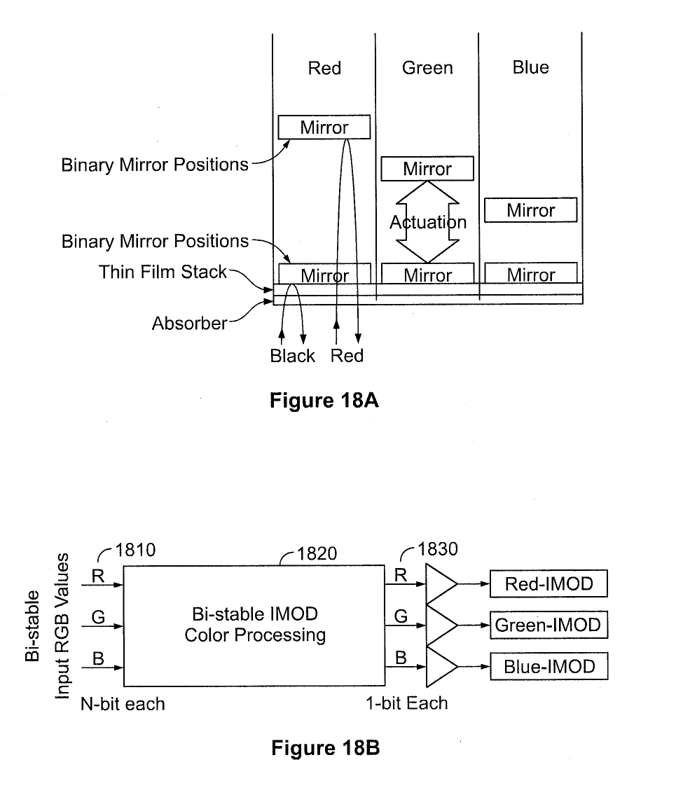

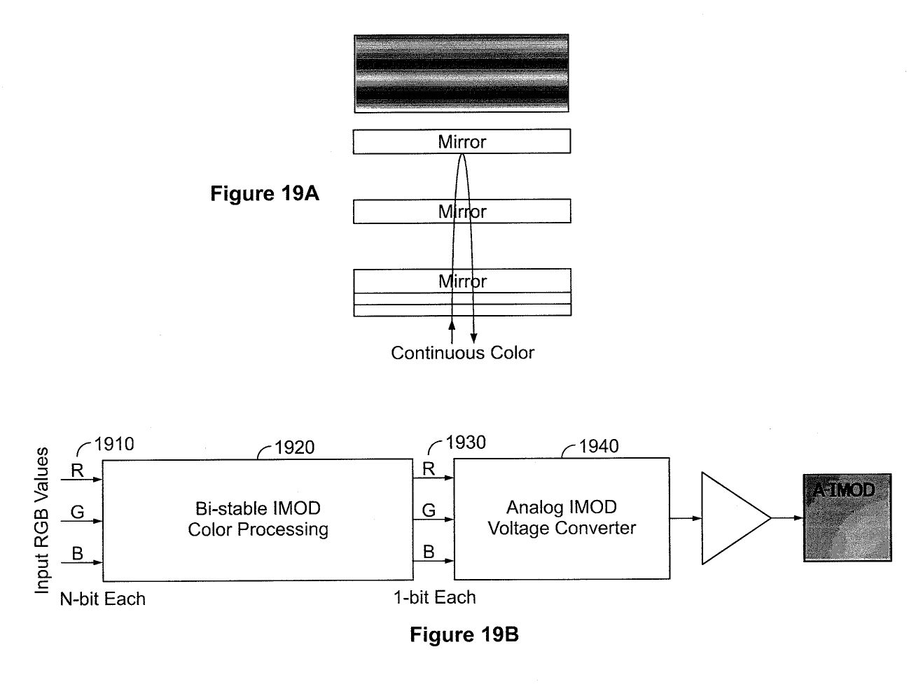

FIG. 19A illustrates one implementation of an analog IMOD producing a more continuous color gamut. In contrast to the bistable IMODs of FIGS. 18A and 18B, the analog IMOD of FIG. 19A includes a movable mirror disposed between two stationary mirrors. The analog IMOD may display a plurality of different colors depending on the position of the movable mirror. This is similar to the analog IMODs illustrated in FIG. 9A or FIG. 9B above. As previously mentioned, the colors generated by the analog IMOD may be distinct and may be separated within a color space. See for example, the IMOD color gamut 1020 illustrated in FIG. 10.

In some implementations, drive voltages or instructions for color rendering of an image may be processed similarly for both bi-stable IMODs and analog IMODs. For example, it may be advantageous to standardize some processor instructions included in software or firmware modules, for example, host program 1230, operating system 1240, or display controller firmware 1220, so the standardized instructions remain the same or similar regardless of whether a bi-stable or analog IMOD is utilized. A smaller portion of instructions, specific to an analog IMOD or a bi-stable IMODs may then be maintained to implement features of the specific IMOD implementation. By reducing the size of the IMOD type specific portion of instructions, efficiencies may be gained in life cycle costs, quality, and time to market.

For example, some implementations may standardize processing instructions for a set of three bi-stable IMODs, such that one of eight different states will be produced as illustrated in FIG. 18B. Due to the physical characteristics of the analog IMOD, however, it may be unable to display each of the eight colors that are displayable by the three bistable IMODs collectively.

FIG. 19B is a data flow diagram for one implementation of a method of driving an analog modulator, for example, the analog modulator illustrated in FIG. 9A, FIG. 9B, or FIG. 19A. In FIG. 19B, the three RGB input values 1910 are first processed utilizing bi-stable IMOD color processing, as described with reference to FIG. 18B. The illustrated implementation may have standardized the portion of instructions responsible for bi-stable IMOD color processing. After bi-stable IMOD processing, the one bit per channel RGB data 1930 passes to the analog IMOD specific voltage converter 1940. The analog IMOD voltage converter 1940 converts the three RGB input bits 1930 to one out of eight voltage levels. The voltage levels may be chosen to correspond to the eight corners of the color parallelepiped 1010 of FIG. 10. These voltage levels may cause a mirror within an analog IMOD to be positioned at a particular level within the IMOD enclosure. For example, the mirror may correspond to electrode 906 illustrated in FIG. 9A, and it may be positioned at positions 930-936 also of FIG. 9A. Any error between the native IMOD color displayed at the corresponding position, and the color represented by inputs 1930 or 1910 may be spatially or temporally diffused. Using this method, one implementation of traditional color processing software or firmware included in, for example, host software 1230, operating system 1240, or display control firmware 1220 of FIG. 12 configured to display color using a traditional RGB color space, such as the RGB parallelepiped 1010 of FIG. 10, can remain unchanged. Additional color processing software or firmware instructions may be included however, in the device of FIG. 12 for example to map the RGB colors to the colors that may be displayed on an analog IMOD display.

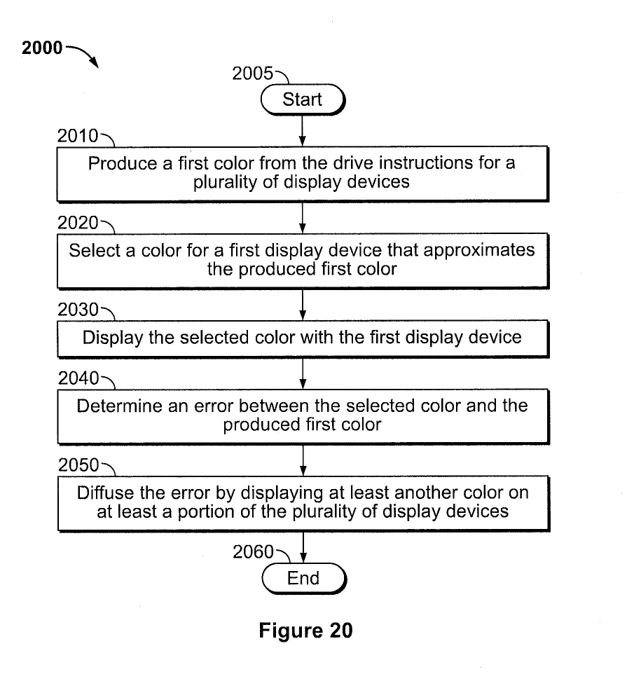

FIG. 20 is a flowchart illustrating one implementation of a method for converting drive instructions for a plurality of display devices to drive instructions for a first display device. Process 2000 may be implemented by instructions included in host software 1230, operating system 1240, or driver controller firmware 1220 of FIG. 12.

Process 2000 begins at start block 2005 and then moves to block 2010, where a first color is produced from the drive instructions for a plurality of display devices. For example, block 2010 may receive as input the R, G, B values 1930 of FIG. 19B. Process 2000 then moves to block 2020, where a color is selected for a first display device that approximates the produced first color. Block 2020 may map the eight possible combinations of R G B values 1930 of FIG. 19B to a native color of an analog IMOD, for example, the analog IMODs illustrated in FIG. 9A, FIG. 9B, or FIG. 19A. Process 2000 then moves to block 2030, where the selected color is displayed with a first display device. For example, block 2030 may display the selected color on an analog IMOD such as that illustrated in FIG. 9A, FIG. 9B, or FIG. 19A. Process 2000 then moves to block 2040, where an error is determined between the selected color and the produced first color. For example, block 2040 may calculate a distance between the produced color within a color map, for example, the RGB parallelepiped 1010 illustrated in FIG. 10, and the displayed color, which, in some implementations, may be positioned on the non-contiguous IMOD color spiral 1020, also illustrated in FIG. 10. Process 2000 then moves to block 2050, where the error is diffused by displaying at least one other color on at least a portion of the plurality of display devices. Block 2050 may utilize temporal or spatial modulation to diffuse the error. Furthermore to diffuse the error, one implementation of block 2050 may implement a variation of process 1600, illustrated in FIG. 16 and described above.

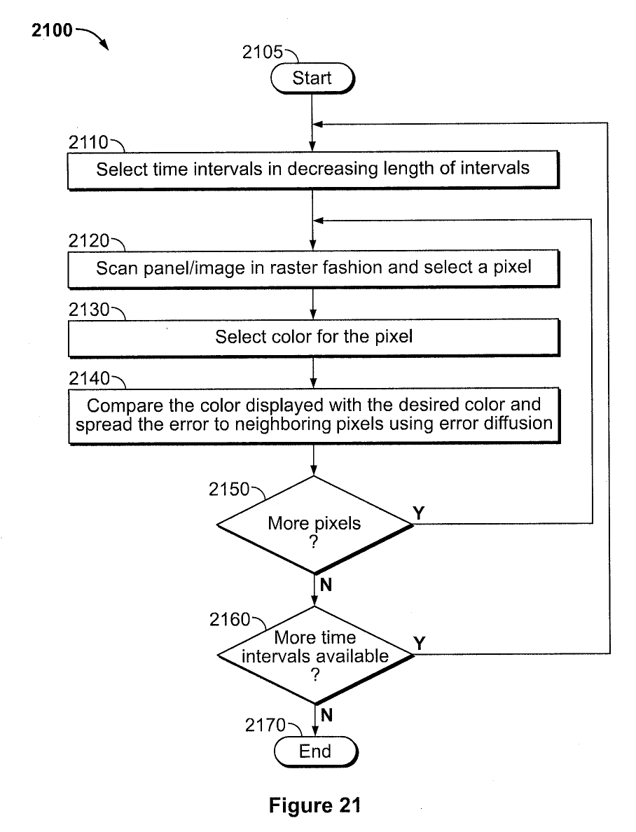

FIG. 21 is a flowchart illustrating one implementation of an error diffusion process. Process 2100 of FIG. 21 may be utilized, for example, to diffuse the error determined in block 2040 of FIG. 20 across several pixels. Before process 2100 begins, a first color may be displayed on an analog IMOD that approximates a desired color. Process 2100 may then diffuse the error between the first color and the desired color. Process 2100 may diffuse the error using spatial modulation. A series of colors may be displayed on a group of pixels in proximity to the pixel that displayed the first color. The display of this series of colors visually simulates the desired color. Process 2100 may be implemented by instructions included in operating system 1240, host program 1230 or display control firmware 1220 of FIG. 12.

Process 2100 begins at start block 2105 and then moves to block 2110, where time intervals to display colors are selected in decreasing length of the intervals. In some implementations, the length of these timeslots may be proportional to the weights described with respect to process 1100 of FIG. 11, process 1300 of FIG. 13, or process 1600 of FIG. 16. Process 2100 then moves to block 2120, where a display panel may be scanned in raster mode, or some image may be scanned, and a particular pixel in the display or image data is chosen for diffusing the error. Process 2100 then moves to block 2130, where a color is selected. In some implementations, the color may be selected from the native analog IMOD color palette. For example, some implementations of block 2230 may utilize Equation 3 or Equation 4 as described above to select the color for the given time interval. Process 2100 then moves to block 2140, where the color displayed via the modulation of the first color and the colors selected to diffuse the error in block 2130 is compared to the desired color. This comparison determines an error value between the desired color and the displayed color. Some implementations may utilize Equation 2 above to calculate the error. Process 2100 then moves to decision block 2150, which determines if there are more pixels available to diffuse the error. If there are more pixels, process 2100 returns to block 2120 and process 2100 repeats. If there are no more pixels, process 2100 moves to decision block 2160 which determines whether there are more time intervals available for error diffusion. If more time intervals are available, process 2100 returns to block 2110 and a new time interval is selected for error diffusion and process 2100 repeats. Otherwise, process 2100 moves to end block 2170.

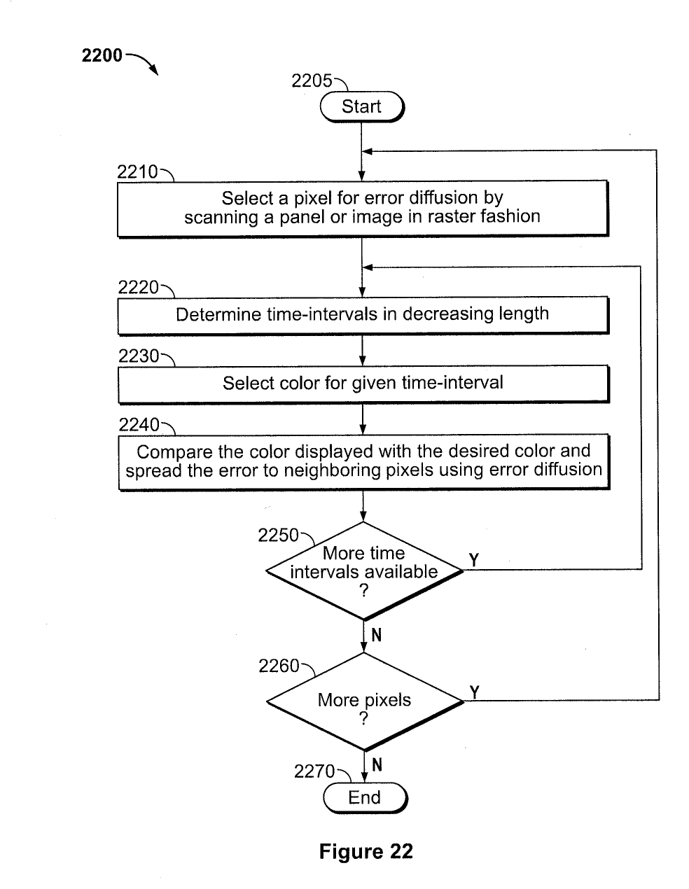

FIG. 22 is a flowchart illustrating one implementation of an error diffusion process. For example, process 2200 of FIG. 22 may diffuse the error determined in block 2040 of FIG. 20 utilizing a particular pixel. Before process 2200 begins, a first color may be displayed on an analog IMOD that approximates a desired color. Process 2200 may then diffuse the error between the first color and the desired color. Process 2200 may diffuse the error using temporal modulation. A series of colors may be displayed on a particular pixel within different time intervals in order to visually simulate a desired color. Process 2200 may be implemented by instructions included in the host program 1230, operating system 1240, or display driver firmware 1220 of FIG. 12.

Process 2200 begins at start block 2205 and then moves to block 2210, where a display panel or image is scanned and a pixel is selected for use in the error diffusion process. This pixel may be the same pixel that displayed the first color, or it may be a different pixel, for example, a pixel in proximity to the pixel that displayed the first color. Process 2200 then moves to block 2220, where time intervals for diffusing the error with the selected pixel are identified by decreasing size of the intervals. In some implementations, the length of these time intervals may be proportional to the weights described with respect to process 1100 of FIG. 11, process 1300 of FIG. 13, or process 1600 of FIG. 16. Process 2200 then moves to block 2230, where a color is selected for a given time interval. In some implementations, the color may be selected from an analog IMOD native color palette. For example, block 2230 may utilize Equation 3 or Equation 4 as described above to select the color for the given time interval. Process 2200 then moves to block 2240, where the displayed color, obtained through the visual combination of the first displayed color and colors selected as part of error diffusion process 2200, is compared to the desired color to determine the visual error between the displayed color and the desired color. Block 2240 may determine the error by utilizing Equation 2 above in some implementations. Process 2200 then moves to decision block 2250, which determines if there remain any additional time intervals for error diffusion with this particular pixel. If more time intervals are available, process 2200 returns to block 2220, and process 2200 repeats. If no more time intervals are available, process 2200 moves to decision block 2260, which determines if any more pixels are available for error diffusion of the displayed color. If there are pixels available, process 2200 moves to block 2210, and process 2200 repeats. Otherwise, process 2200 moves to end block 2270.

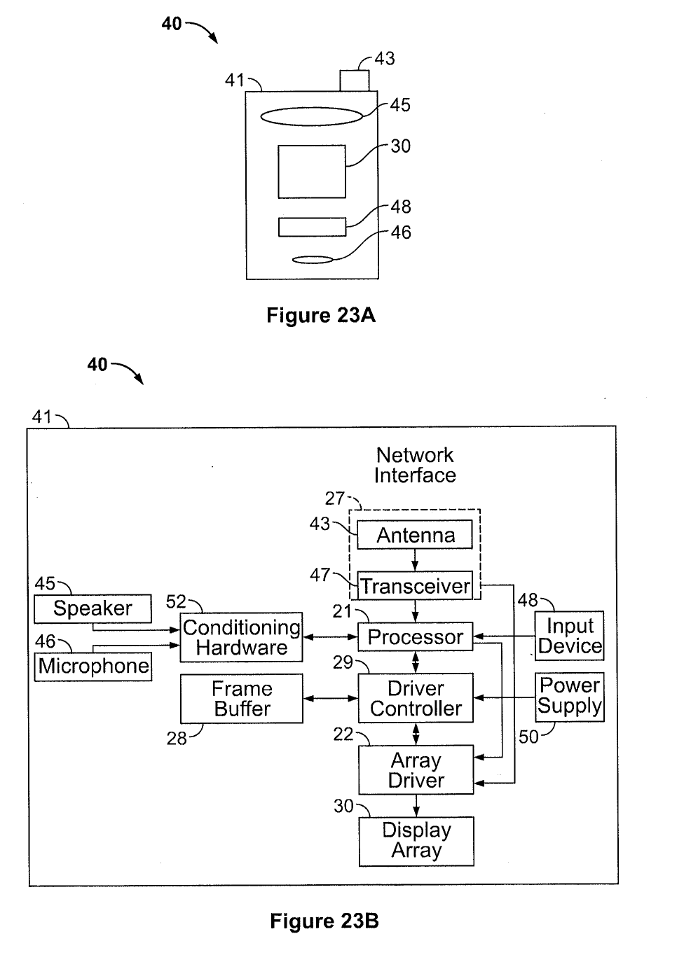

FIGS. 23A and 23B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 23B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to some or all of the components of the particular display device 40 design.

The network interface 27 includes the antenna 43 and the transceiver 47 so that the display device 40 can communicate with one or more devices over a network. The network interface 27 also may have some processing capabilities to relieve, e.g., data processing performed by the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image daia to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of converting drive instructions for a plurality of display devices to drive instructions for a first display device, comprising:
processing the drive instructions for the plurality of display devices to produce a first color in a set of potential colors for the plurality of display devices;
selecting a color for the first display device that approximates the produced first color;
displaying the selected color with the first display device;
determining an error between the selected color and the produced first color; and
diffusing the error by displaying at least another color on at least a portion of the plurality of display devices.

2. The method as recited in claim 1, wherein the plurality of display devices include bistable IMODs, and wherein the first display device includes an analog IMOD.

3. The method as recited in claim 2, wherein there are three bistable IMODs, and wherein the set of potential colors corresponds to eight display states or voltage level combinations for the three bistable IMODs.

4. The method as recited in claim 1, wherein the error is temporally diffused to a subsequent display period.

5. The method as recited in claim 1, wherein the error is diffused to one or more adjacent display devices.

6. The method as recited in claim 1, wherein each of the colors in the set of potential colors corresponds to a predetermined closest color of the first display device.

7. An apparatus for converting drive instructions for a plurality of display devices to drive instructions for a first display device, comprising:
an electronic display including a plurality of display devices;
an electronic processor configured to communicate with the display, the processor being configured to process image data; and configured to
process the drive instructions for the plurality of display devices to produce a first color in a set of potential colors for the plurality of display devices,
selecting a color for the first display device that approximates the produced first color,
displaying the selected color with the first display device,
determining an error between the selected color and the produced first color;
diffusing the error by displaying at least another color on at least a portion of the plurality of display devices.

8. The apparatus as recited in claim 7, further comprising: a memory device that is configured to communicate with the processor.

9. The apparatus as recited in claim 7, further comprising a driver circuit configured to send at least one signal to the display.

10. The apparatus as recited in claim 9, further comprising a controller configured to send at least a portion of the image data to the driver circuit.

11. The apparatus as recited in claim 7, further comprising an image source module configured to send the image data to the processor.

12. The apparatus as recited in claim 11, wherein the image source module includes at least one of a receiver, transceiver, and transmitter.

13. The apparatus as recited in claim 7, further comprising an input device configured to receive input data and to communicate the input data to the processor.

14. The apparatus as recited in claim 7, wherein the electronic display comprises analog IMODs.

15. The apparatus as recited in claim 7, further comprising a wireless telephone handset.

16. A display apparatus comprising:
means for processing the drive instructions for a plurality of display devices to produce a first color in a set of potential colors for the plurality of display devices;
means for selecting a color for a first display device that approximates the produced first color;
means for displaying the selected color with the first display device;
means for determining an error between the selected color and the produced first color;
means for diffusing the error by displaying at least another color on at least a portion of the plurality of display devices.

17. A non-transitory, computer readable storage medium having instructions stored thereon that cause a processing circuit to perform a method comprising:
processing the drive instructions for a plurality of display devices to produce a first color in a set of potential colors for the plurality of display devices;
selecting a color for a first display device that approximates the produced first color;
displaying the selected color with the first display device;
determining an error between the selected color and the produced first color;
diffusing the error by displaying at least another color on at least a portion of the plurality of display devices.
